(19) United States
(12) Patent Application Publication
(10) Pub. No.: US 2012/0306909 A1
(43) Pub. Date: Dec. 6, 2012

(54) INFORMATION PROCESSOR, INFORMATION PROCESSING METHOD AND PROGRAM

(76) Inventors: Daisuke Mochizuki, Chiba (JP); Tatsuhito Sato, Tokyo (JP)

(21) Appl. No.: 13/480,508

(22) Filed: May 25, 2012

(30) Foreign Application Priority Data
Jun. 3, 2011 (JP) 2011-124759

(51) Int. Cl. G09G 5/00

(52) U.S. Cl. 345/619

(57) ABSTRACT

Provided is an information processor, including a display format selection control section that selects, in accordance with a display screen, a display format for displaying at least a part of a feature space prescribed based on a predetermined feature quantity and a set of content data associated with positional information representing a position in the feature space as metadata, and a node selecting section that uses a tree structure, in which the content data are prescribed as leaf nodes and a set of nodes, in which the distance between the nodes in the feature space satisfies predetermined conditions, is prescribed as a parent node of the nodes satisfying the predetermined conditions, to select a node which satisfies the predetermined conditions from the nodes included in the tree structure in accordance with the size of a displayed feature space as the feature space displayed on the display screen.

### BACKGROUND

The present disclosure relates to an information processor, an information processing method and a program.

There is a technique called clustering for creating a group of data which are positioned in a close distance within a feature space prescribed by a predetermined feature quantity, and the technique is widely applied to various fields. Also, there is a technique widely used to create a tree-like data structure by grouping data included in clusters generated by the clustering.

The data structure, which is thus created, has a configuration to have such structure that an upper hierarchy includes a lower hierarchy. Therefore, the data structure is used for searching for desired data by selecting from a group having coarser granularity to a group having finer granularity in order. Also, the data structure is used to create new groups of certain data each having different granularity by changing the hierarchy (refer to, for example, Japanese Patent Application Laid-Open Publication No. 2007-122562).

When searching for a data group, many users trace in order from the top the hierarchy structure which is formed by clustering technique to obtain desired data. The Japanese Patent Application Laid-Open Publication No. 2007-122562 teaches a technique to provide a display screen which allows users to instinctively comprehend a hierarchy structure and provide easy data search.

When data as a target of search are cleared, the search method disclosed in the Japanese Patent Application Laid-Open Publication No. 2007-122562 is effective. However, when searching for content data like pictures which have a similar situation, for example, as the situation the contents are generated (for example, contents of pictures which taken at a generally identical location), it is more convenient to browse or search for the data based on a piece of presently focused data.

Under such circumstances, in these days, new applications and services are under development, which are capable of displaying a list of contents based on a specified location.

### SUMMARY

However, in a known application for displaying a list of contents which used a specified position as a reference as describe above, since every contents were displayed on a display screen, there was a problem that the display screen got cluttered.

Accordingly, the present disclosure proposes an information processor, an information processing method and a program capable of providing information on contents without cluttering the display screen.

According to an embodiment of the present disclosure, there is provided an information processor, including: a display format selection control section that selects, in accordance with a display screen, a display format for displaying at least a part of a feature space prescribed based on a predetermined feature quantity and a set of content data associated with positional information representing a position in the feature space as metadata in combination with each other; and a node selecting section that uses a tree structure, in which the content data are prescribed as leaf nodes and a set of nodes, in which the distance between the nodes in the feature space satisfies predetermined conditions, is prescribed as a parent node of the nodes satisfying the predetermined conditions, to select a node which satisfies the predetermined conditions from the nodes included in the tree structure in accordance with the size of a displayed feature space as the feature space displayed on the display screen, wherein the node selecting section selects, from the nodes positioned outside of the displayed feature space, a node as an exo-display screen node positioned outside of the display screen, which has a largeness in the feature space corresponding to a separation distance from the displayed feature space of the relevant node, and wherein the display format selection control section causes an object which indicates the existence of the exo-display screen node selected by the node selecting section to be displayed within the display screen.

According to another embodiment of the present disclosure, there is provided an information processing method, including: selecting nodes that satisfy predetermined conditions from nodes included in a tree structure in accordance with the size of a displayed feature space which is a feature space to be displayed on a display screen by using the tree structure that includes content data as a leaf node, which is associated with positional information representing a position in the feature space prescribed based on a predetermined feature quantity as metadata and a set of nodes in which the distance among the nodes in the feature space satisfies predetermined conditions is prescribed as a parent node of the nodes which satisfy the relevant predetermined conditions; and selecting a display format for displaying at least a part of the feature space and at least a part of the selected nodes in accordance with the display screen, wherein, when selecting the nodes, a node which has a largeness in the feature space corresponding to the separation distance from the displayed feature space of the relevant node is selected as an exo-display screen node which is positioned outside of the display screen from the nodes positioned outside of the displayed feature space, and wherein when selecting the display format, an object indicating existence of the selected exo-display screen node is caused to be displayed within the display screen.

According to still another embodiment of the present disclosure, there is provided a program causing a computer to perform: a display format selection control function that selects, in accordance with a display screen, a display format for displaying at least a part of a feature space prescribed based on a predetermined feature quantity and a set of content data associated with positional information representing a position in the feature space as metadata in combination with each other; and a node selecting function that uses a tree structure in which the content data are prescribed as leaf nodes and a set of nodes in which the distance between the nodes in the feature space satisfies predetermined conditions is prescribed as a parent node of the nodes satisfying the predetermined conditions to select a node which satisfies the predetermined conditions from the nodes included in the tree structure in accordance with the size of a displayed feature space as the feature space displayed on the display screen, wherein the node selecting function selects, from the nodes positioned outside of the displayed feature space, a node as an exo-display screen node positioned outside of the display screen, which has a largeness in the feature space corresponding to a separation distance from the displayed feature space of the relevant node, and wherein the display format selection control function causes an object which indicates the existence of the exo-display screen node selected by the node selecting section to be displayed within the display screen.

According to the embodiment of the present disclosure, the display format selection control section selects, in accordance with a display screen, a display format for displaying at least a part of a feature space prescribed based on a predetermined feature quantity and a set of content data associated with positional information representing a position in the feature space as metadata in combination with each other; and a node selecting section that uses a tree structure in which the content data are prescribed as leaf nodes and a set of nodes, in which the distance between the nodes in the feature space satisfies predetermined conditions, is prescribed as a parent node of the nodes satisfying the predetermined conditions to select a node which satisfies the predetermined conditions from the nodes included in the tree structure in accordance with the size of a displayed feature space as the feature space displayed on the display screen. At this time, the node selecting section selects, from the nodes positioned outside of the displayed feature space, a node as an exo-display screen node positioned outside of the display screen, which has a largeness in the feature space corresponding to a separation distance from the displayed feature space of the relevant node, and the display format selection control section causes an object which indicates the existence of the exo-display screen node selected by the node selecting section to be displayed within the display screen.

As described above, the present disclosure is capable of providing information on contents without cluttering the display screen.

### BRIEF DESCRIPTION OF THE DRAWINGS

FIG. 1 is an illustration for explaining a tree structure;

FIG. 2 is an illustration for schematically explaining a clustering used in an information processor according to a first embodiment of the present disclosure;

FIG. 3 is an illustration for explaining an information processor according to the embodiment;

FIG. 4 is an illustration for explaining the information processor according to the embodiment;

FIG. 5 is a block diagram showing a configuration of the information processor according to the embodiment;

FIG. 6 is a diagram for explaining a metadata associated with a cluster;

FIG. 7A is a diagram for explaining an example of a control method of a display screen according to the embodiment;

FIG. 7B is a diagram for explaining the example of the control method of the display screen according to the embodiment;

FIG. 8A is a diagram for explaining the example of the control method of the display screen according to the embodiment;

FIG. 8B is a diagram for explaining the example of the control method of the display screen according to the embodiment;

FIG. 9 is an illustration for explaining a processing of cluster selection carried out by the information processor according to the embodiment;

FIG. 10 is an illustration for explaining an example of a cluster generating method;

FIG. 11 is an illustration for explaining the example of the cluster generating method;

FIG. 12A is a diagram for explaining the example of the cluster generating method;

FIG. 12B is a diagram for explaining the example of the cluster generating method;

FIG. 12C is a diagram for explaining the example of the cluster generating method;

FIG. 12D is a diagram for explaining the example of the cluster generating method;

FIG. 12E is a diagram for explaining the example of the cluster generating method;

FIG. 13 is an illustration for explaining the example of the cluster generating method;

FIG. 14A is an illustration for explaining a distance between the clusters;

FIG. 14B is an illustration for explaining the distance between the clusters;

FIG. 14C is an illustration for explaining the distance between the clusters;

FIG. 15 is an illustration for explaining an example of the cluster generating method;

FIG. 16 is a flow diagram illustrating an entire flow of the information processing method according to the embodiment;

FIG. 17 is a flow diagram illustrating a flow of processing of cluster selection in the information processing method according to the embodiment;

FIG. 18 is a block diagram for explaining a first example of a modification of the information processor according to the embodiment;

FIG. 19 is a block diagram for explaining the first example of the modification of the information processor according to the embodiment; and

FIG. 20 is a block diagram illustrating a hardware configuration of the information processor according to the embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be made in the following order.

(1) Tree structure
(2) First embodiment

(2-1) Outline of clustering used in the information processor

(2-2) Configuration of the information processor

(2-3) Flow of information processing method

(2-4) First example of modification

(3) Hardware configuration of an information processor according to an embodiment of the present disclosure

### (Tree Structure)

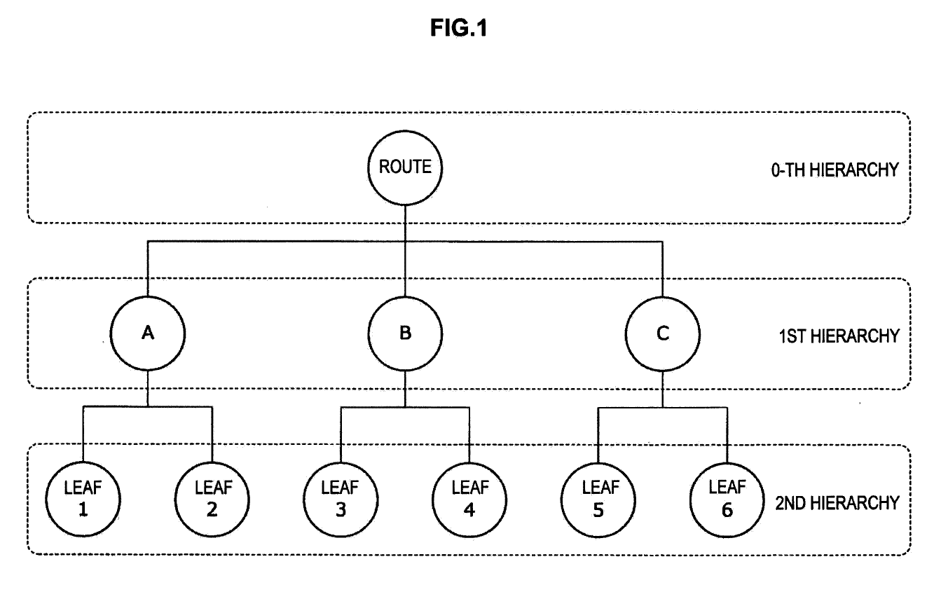

Before describing embodiments according to the present disclosure, several terms relevant to a tree structure which are used in the description will be briefly described referring to FIG. 1. FIG. 1 is an illustration for explaining the tree structure.

The tree structure includes a plurality of elements (marked with a circle in FIG. 1) as shown in FIG. 1. Each of the plurality of elements is referred to as node. In the tree structure, a node positioned at the top is referred to as route node. As viewed from the route node, several branches extend downward from the route node in the figure, and at the end of each branch, a node is positioned respectively. By repeating branching as described above, the tree structure is formed to have a multilayered structure as shown in FIG. 1. In the tree structure, a node positioned at the bottom is referred to as a leaf node. As illustrated in the figure, no branch extends from the leaf nodes.

Here, when focusing to a node “B” shown in FIG. 1, a branch extending upward from the node B is connected to a route node; and branches extending downward from the node B are connected to two nodes (leaf nodes) of a leaf 3 and a leaf 4. Herein, a node, which is directly connected to a branch extending upward (i.e. toward the route node) like the route node with respect to the node B, will be referred to as parent node. Also, a node, which is directly connected to a branch extending downward (i.e. in a direction opposite to the direction toward route node) with respect to the node B like the leaf 3 and the leaf 4, will be referred to as child node.

Naming of “parent node” and “child node” is just a relative naming. When focused node is changed, the naming is also changed. For example, the node B is the parent node with respect to the leaf 3 or leaf 4, but the node B is a child node with respect to the route node.

The tree structure has a multilayered structure as shown in FIG. 1. Hereinafter, a hierarchy to which the route node belongs will be referred to as 0-th hierarchy; a hierarchy to which a child node of the route node belongs will be called as first hierarchy; and a hierarchy to which a child node of the node which is positioned at the first hierarchy will be referred to as second hierarchy. Hereinafter, the hierarchies will be referred to as a third hierarchy, a fourth hierarchy . . . in order as necessary.

When focusing to the node B, child nodes other than the focused node, which are branched from the parent node of a certain node like the node A and node C, will be referred to as sibling node. For example, when focusing to the leaf 3 in FIG. 1, a sibling node thereof is the leaf 4.

FIG. 1 shows an example of a case where a plurality of branches extend from a certain node. However, the number of the branches extending downward (i.e. in a direction opposite to the direction toward route node) may be only one. Also, the number of the branches extending from a certain node is not limited to the example shown in FIG. 1.

### First Embodiment

### <Outline of Clustering Used in the Information Processor>

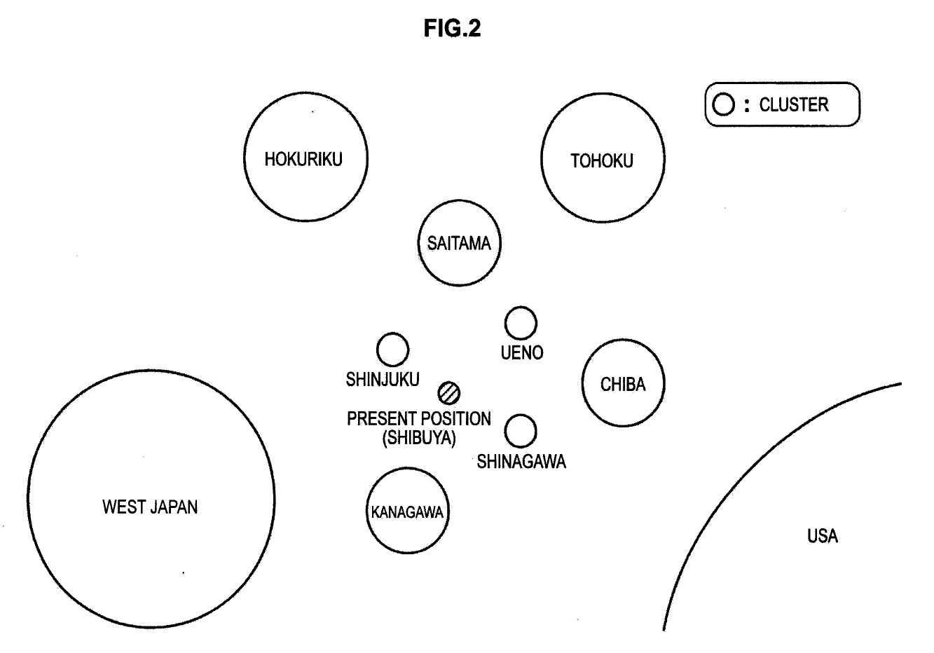

Then, referring to FIG. 2, outline of the clustering used in the information processor according to a first embodiment of the present disclosure is described.

As described above, when grouping (clustering) data, there may be a case the data is desirably grouped in such a manner that, defining a certain point as a reference, data located near the certain point is divided into a fine granularity, while data located far away from the certain point is grouped into a coarse granularity.

For example, it is assumed a case of an apparatus which displays neighboring recommended spots corresponding to the present position on a map. In this case, it is assumed that spots located near the present position are displayed without being grouped (or, grouping on 1 data=1 group basis). Also, it is assumed that spots located a little away from the present position are displayed being grouped on municipality basis, while spots located far away from the present position are displayed being grouped on country basis.

FIG. 2 shows an example of a grouping result of which when the present position is located in the vicinity of Shibuya in Tokyo, the granularity of the group (i.e. cluster) is changed corresponding to the distance from Shibuya. It is understandable that clusters representing positions of “Shinjuku”, “Ueno” and “Shinagawa” which are groups (clusters) located near the present position of Shibuya are displayed in a finer granularity respectively; and the granularity of clusters gets coarser as the distance from the present position increases.

With a display provided on an apparatus as described above, it is possible for a user to easily and roughly comprehend a positional relationship between the clusters displayed. When such apparatus is achieved, user's convenience can be increased as a result.

When it is desired to classify the size of groups based on the distance from a specified position as the above-described example, with this grouping, clustering can be made while considering the distance from the certain point to the data in addition to an absolute position of data on a feature space.

However, in such clustering, especially when the data size is large, the load of operation amount becomes larger. Therefore, If spots are grouped based on the present position as the above example, corresponding to the present position which continuously changes as time passes, when the clustering is executed from the beginning every time as the present position changes, a large load is imposed to a system.

In the case of the clustering based on actual present position, for example in the real world, since extremely high speed movement is not conceivable, such application may be possible that the present position is updated for example, once a minute. However, when it is intended to achieve the same technique in a virtual world, such as in the case where it is hard to predict when and how much a specific position changes, it is difficult to achieve the clustering.

Considering such circumstances, the information processor according to the embodiment described below uses a tree structure representing a cluster structure generated according to the clustering that generates a cluster structure of multi-hierarchy having different granularity of the cluster. Also, in the information processor according to the embodiment, when an area is specified in a feature space prescribing the cluster structure, a desired cluster will be extracted from various hierarchies by using the specified area and the generated cluster structure. With this, the information processor according to the embodiment enables to perform clustering that granularity of the cluster is changed based on the distance from the specific area in the feature space while reducing the load required for the clustering.

### <Configuration of the Information Processor>

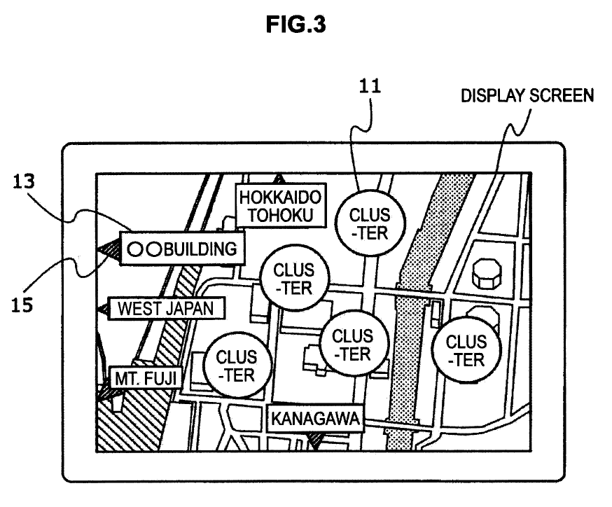

Now, the configuration of the information processor according to the embodiment is described in detail while referring to FIG. 3-FIG. 15.

### [Outline of the Information Processor]

The information processor according to the embodiment uses a tree structure in which various kinds of content data are disposed under a predetermined condition, and the information processor displays a group (i.e. cluster) on the display screen, in which content data or a group of content data is arranged based on a certain rule. The information processor according to the embodiment uses a tree structure in which content data, which are associated with positional information representing a location of a feature space as metadata based on a predetermined feature quantity, are prescribed as leaf nodes; and a set of nodes, in which the distance between the nodes in a feature space satisfies predetermined conditions, is prescribed as a parent node of the nodes which satisfy the predetermined conditions.

As for examples of the content data handled by the information processor according to the embodiment, image contents such as still image contents, motion picture contents, various kinds of character information, image information or the like, which are registered in a server or the like to share various kinds of information among users are given. In addition to above data, the following contents including, for example, mail, music, schedule, electronic money usage record, phone call record, content view record, sightseeing information and local information, news and weather forecast, ring alert mode record or the like are available.

The following description will be made while taking image contents such as still image content or motion picture content as examples. However, when the positional information representing a position in the feature space is data attached as, for example, metadata, the information processor according to the embodiment is able to handle an arbitrary information or content data.

The data representing content data and various kinds of information as described above are preferably stored in the information processor. However, when data main body is stored in an apparatus such as a server which is provided outside of the information processor, the information processor may store metadata corresponding to the data main body. In the following description, an example in which the information processor stores data representing content data and various kinds of information along with metadata, is given.

As for an example of a predetermined feature quantity stored in the metadata, for example, a piece of information on degrees of latitude and longitude for identifying a location where the content is generated, a piece of information on clock time when the content is generated, a piece of information on address representing a location where the content is generated and the like are given. The metadata on the predetermined feature quantity may be stored in, for example, an Exif (exchangeable image file format) tag associated with content data.

The information on degrees of latitude and longitude for identifying location is, for example, information which can be obtained by obtaining or analyzing GPS signal. The positional information like degrees of latitude and longitude is a feature quantity for identifying a position on the surface of a spherical earth (position on the surface of the earth). Therefore, feature space prescribed based on the information on the degrees of latitude and longitude is a space representing a position on a spherical surface of the earth. Needless to say, the position in such feature space may be defined by specifying the degree of latitude and the degree of longitude respectively. Also, the distance between two positions on the feature space can be defined by using a so-called great circle distance.

Also when the information representing a position on the surface of the earth is used as the feature quantity, and when the focused area is a local area, the surface of the earth may be assumed as an approximate plane. Therefore, the feature space may be prescribed by using degree of latitude as x-coordinate, and the degree of longitude as y-coordinate. The feature space in this case is the plane space (Euclidean space) prescribed by two-dimensional vectors like (x, y), and the distance between two positions on the feature space may be defined using so-called Euclidean distance.

When the information on clock time of generation of content is used as the feature quantity, the feature space is prescribed based on the one-dimensional information of time. Therefore, the feature space in this case is defined by the clock time as a scalar quantity, and the distance between two positions on the feature space may be defined by a difference of clock time.

The degree of such feature space is not limited to one-dimension or two-dimension. For example, the feature space may be handled as a three-dimensional space considering a width direction, a height direction and a depth direction, and further a space of four-dimensional or more may be handled as the feature space.

The tree structure representing a clustering result of contents, which is made based on a distribution of contents in the feature space, has the following characteristics.

(1) Content data corresponds to leaf node.
(2) Data which are positioned in a distance close to each other on a feature space are included in a same node.
(3) When a node itself, which includes data positioned in a distance close to each other, is positioned in a distance close to other node, these nodes are included in a same node.
(4) Plural nodes, which are classified in a same hierarchy level, have the similarity in node size.

In addition to the characteristics listed in (1)-(4) above, the tree structure used in the information processor according to the embodiment may further have the following characteristic.

(5) Excepting the nodes which have parent-child relationship, an area in the feature space of one node does not overlap with an area in the feature space of the other node.

The clustering of contents which are associated with metadata of positional information may be made based on a distance in the feature space as described above. However, for example, the clustering may be made based on address hierarchy by focusing administrative district such as prefectural and city governments or municipality, from a view point that the respective nodes are included in a same administrative district, and so on. Further, the clustering may be made by using a metadata different from a view point such as distance in a feature space or administrative district.

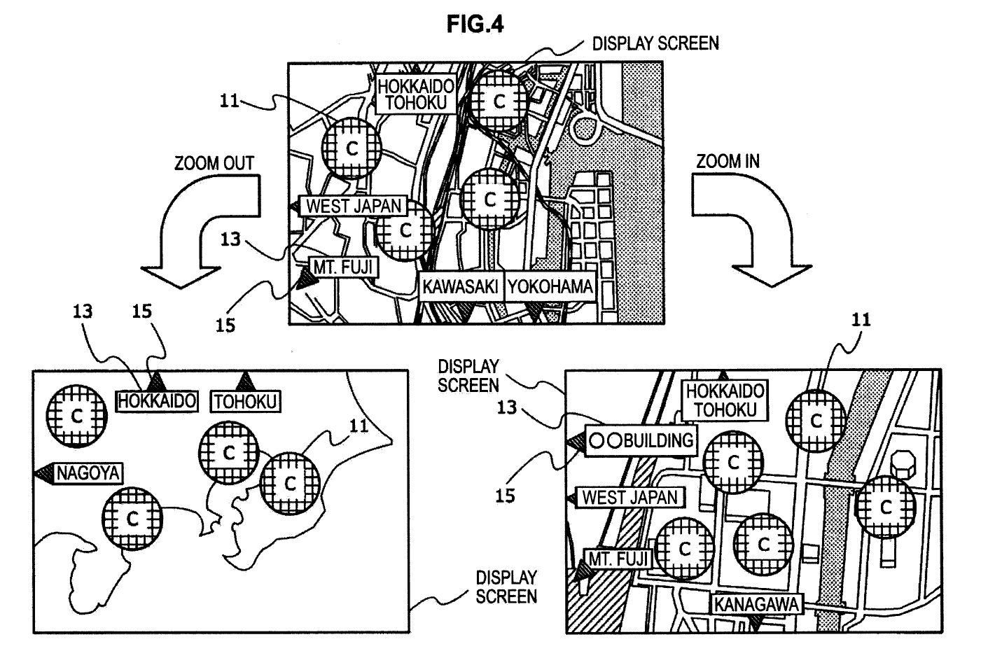

FIG. 3 and FIG. 4 illustrate an example of the display screen of the information processor according to the embodiment. In the example shown in FIG. 3, the content data is associated with positional information representing a position on the earth surface, and clusters are displayed along with map information corresponding to the feature space. The information processor according to the embodiment adjusts the granularity of the cluster 11 displayed within the display screen corresponding to the size of the feature space displayed on the display screen, and adjusts the granularity of the clusters which are not displayed within the display screen in accordance with the distance between the cluster and the display screen. After that, the information processor according to the embodiment indicates existence of clusters which are not displayed within the display screen with a label 13 that indicates a name of the cluster and a direction indicator 15 that indicates existing position of the cluster on the display screen to notify the user.

It is assumed that a display screen shown in upper portion in FIG. 4 is displayed on a display device of the information processor at a certain time. Here, when the user makes a zoom-in operation, the scale of the map, which is displayed on the display screen is reduced as shown in right-lower portion in FIG. 4, and accompanying such change, the size (granularity of the cluster) of the cluster 11 displayed within the display screen is also reduced. As a result, in the display screen shown in the upper portion in FIG. 4, for example, assuming that the size of the cluster 11 is 1 km in radius, in the display screen shown in the right-lower portion in FIG. 4, for example, the size of the cluster 11 changes to 200 m in radius. On the other hand, when the user makes a zoom-out operation on the display screen shown in the upper portion in FIG. 4, as shown in the left-lower portion in FIG. 4, the scale of the map displayed on the display screen gets larger, and accompanying such change, the size of the cluster 11 displayed within the display screen also gets larger.

As a result, in the display screen shown in the upper portion in FIG. 4, assuming that, for example, the size of the cluster 11 is 1 km in radius, in the display screen shown in the left-lower portion in FIG. 4, for example, the size of the cluster 11 changes to 10 km in radius.

Accompanying the change of the granularity of the cluster displayed on the display screen, the granularity of the clusters existing out of the display screen also changes, and the size of the name on the label 13 displayed within the display screen and the direction indicator 15 also changes. Here, as shown in FIG. 4, for example, by adapting so that an item which exists closer to the display screen among the clusters existing out of the display screen is displayed with a larger label 13, the convenience of the user's operation can be enhanced. The display control method of the label 13 and direction indicator 15 will be described later.

As for particular examples of the information processor according to the embodiment, for example, mobile communication equipment such as personal computer, car navigation system, mobile phone and smart phone; portable content players such as portable game console, portable music player and portable motion picture player; imaging apparatuses such as tablet mobile terminal, digital still camera and digital video camera; various kinds of digital home electronics; content management view service linked with map service on a network are given; but are not limited to the examples above.

### [Configuration of the Information Processor]

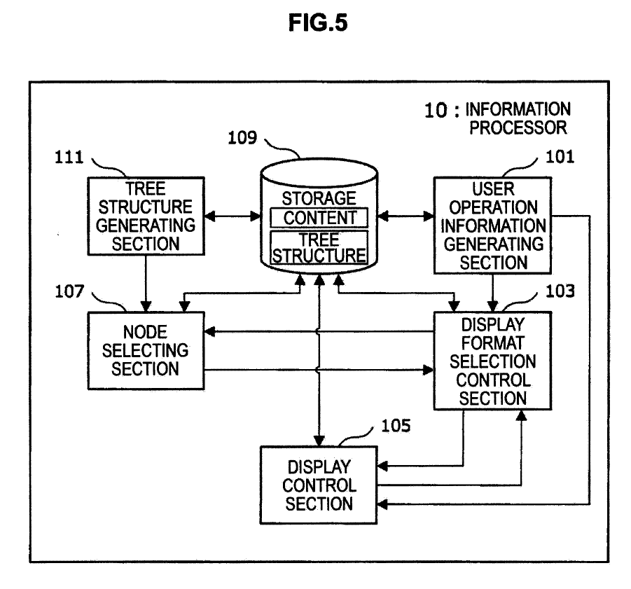

Now, referring to FIG. 5, the configuration of the information processor 10 according to the embodiment will be described in detail. FIG. 5 is a block diagram showing the configuration of the information processor 10 according to the embodiment.

The information processor 10 according to the embodiment includes mainly a user operation information generating section 101, a display format selection control section 103, a display control section 105, a node selecting section 107 and a storage 109 as shown in FIG. 5. In addition to these processing sections, the information processor 10 according to the embodiment may further include a tree structure generating section 111.

The user operation information generating section 101 includes, for example, a CPU (central processing unit), a ROM (read only memory), a RAM (random access memory), an input device and the like. The user operation information generating section 101 generates user's operation information representing operation (user's operation) which is made by a user using an input device including a keyboard, a mouse, various kinds of buttons, a touch panel and the like provided to the information processor 10. After generating the user's operation information representing the user's operation, the user operation information generating section 101 outputs the generated user's operation information to the display format selection control section 103 and the display control section 105 described below.

The display format selection control section 103 includes, for example, a CPU, a ROM, a RAM and the like. The display format selection control section 103 selects a display format for displaying at least a part of feature space, which is prescribed based on a predetermined feature quantity, and content data or a set of content data (cluster) while adjusting the size thereof to the display screen while collaborating with the display control section 105 and the node selecting section 107 described below. The tree structure may be previously generated in the information processor 10 according to the embodiment; or may be previously generated in various kinds of devices (for example, an information processing server or the like existing on a network) capable of communicating with the information processor 10.

For example, when user's operation information requesting to start display of a cluster on the display screen or user's operation information requesting to shift display area displayed on the display screen is notified from the user operation information generating section 101, the display format selection control section 103 refers to an initial setting value or the like stored in the storage 109 or the like described below to specify the size of the feature space to be displayed on the display screen (for example, a map plane representing a position on the earth surface). After that, the display format selection control section 103 determines the granularity (cluster size) of a cluster to be displayed on the display screen in accordance with the size of the specified feature space, and notifies the information on the size of the specified feature space and the granularity of determined cluster to the node selecting section 107 described below. With this, a cluster to be displayed on the display screen is selected by the node selecting section 107 described below. When the information indicating the cluster to be displayed on the display screen is notified from the node selecting section 107, the display format selection control section 103 determines a display format for the cluster to be displayed, and causes the display control section 105 described below to carry out the display control of the cluster.

When the user's operation information requesting change of the size of the feature space displayed on the display screen is notified from the user operation information generating section 101, the display format selection control section 103 specifies the size of the feature space being displayed at that time. After that, the display format selection control section 103 changes the size of the feature space to be displayed on the display screen by responding to the notified user's operation information. The display format selection control section 103 determines the granularity (cluster size) of the cluster to be displayed on the display screen according to the size of the changed feature space, and notifies the information on the size of the changed feature space and granularity of the determined cluster to the node selecting section 107 described below. With this, the cluster to be displayed on the display screen is selected by the node selecting section 107 described below. When the information indicating the cluster to be displayed on the display screen is notified from the node selecting section 107, the display format selection control section 103 determines the display format for the cluster to be displayed, and causes the display control section 105 described below to carry out the display control of the cluster.

Here, it may be adapted so that, the granularity of the cluster displayed within the display screen is preset based on the size (for example, size of selectable map plane, reduction scale of selectable map plane and the like) of the feature space selectable by the display format selection control section 103, and the display format selection control section 103 selects the granularity of the cluster according to the preset value. Also it may be adapted so that the display format selection control section 103 determines the granularity of the cluster based on a predetermined calculating formula using the size of the feature space to be displayed on the display screen. The method with which the display format selection control section 103 determines the granularity of the cluster is not limited to the above example, but the display format selection control section 103 may determine the granularity of the cluster using an arbitrary method.

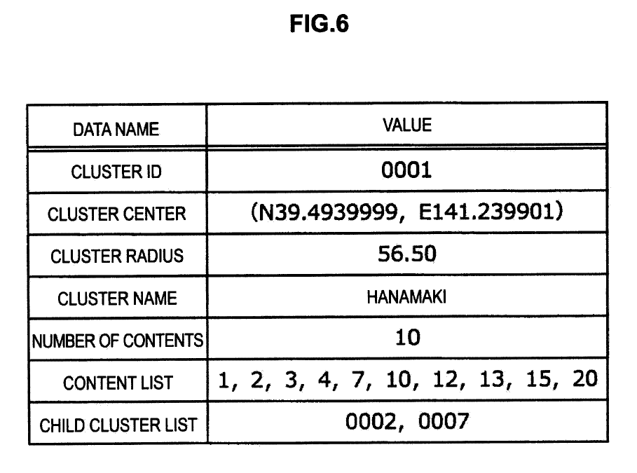

In the embodiment, each of the clusters corresponding to the nodes respectively of the tree structure is associated with a piece of metadata as shown in FIG. 6. Hereinafter, the metadata is referred to as cluster data.

The cluster data is a piece of information unique to each of the generated clusters. As shown in FIG. 6, the cluster data stores identification information unique to the cluster (cluster ID), information on center position and radius of the cluster, the number of contents included in the cluster, a content list, a list of child clusters and the like.

The cluster ID is a piece of identification information unique to the cluster corresponding to the cluster data, in which, for example, a 4-digit integer value is recorded. The cluster center position is a piece of data indicating the center position of the cluster corresponding to the cluster data, in which a piece of information specifying a position in the feature space (for example, information representing degrees of latitude and longitude corresponding to center position of the cluster) is recorded. The cluster radius is a piece of data indicating the radius of the cluster corresponding to the cluster data, which is recorded with an arbitrary format suitable to represent a feature space prescribing a feature quantity; for example, a value with a unit of meter (m). The cluster name is a piece of data representing a name associated with the cluster. The number of contents is a piece of data representing the number of contents included in an area of the cluster corresponding to the cluster data. The content data list is a data representing an ID of a content included in the area of the cluster corresponding to the cluster data (in FIG. 6, integer value is used), and for example, a list of integer values is recorded as the content ID.

When displaying a selected cluster, in order to allow a user to recognize existence of a cluster positioned out of the display screen (hereinafter, occasionally referred to simply as cluster out of display screen), the display format selection control section 103 is capable of displaying a label 13 and a direction indicator 15 as shown in FIG. 3 and FIG. 4. Hereinafter, the label 13 and the direction indicator 15 may be occasionally referred to as a cluster object.

Here, as shown in FIG. 3 and FIG. 4, there may be a case where a plurality of cluster objects is disposed in the display screen. In such a case, the display format selection control section 103 preferably adjusts the display position so that the cluster objects such as the label 13 and the direction indicator 15 overlap with each other as little as possible.

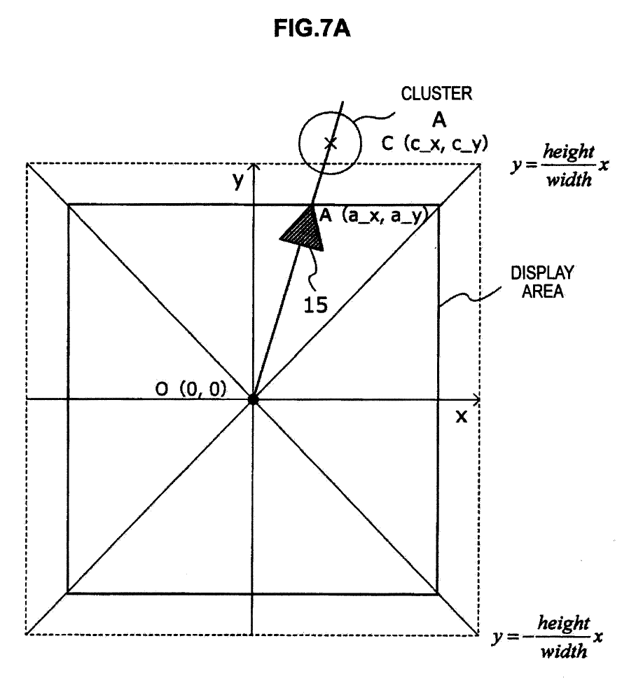

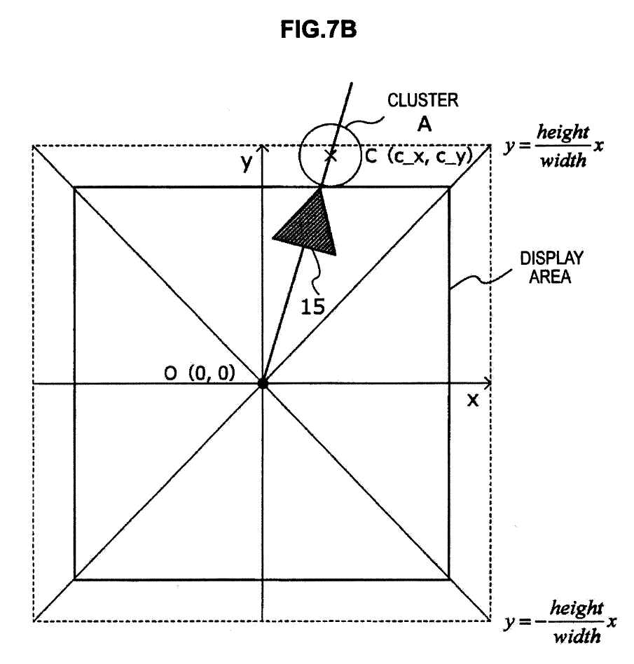

The direction indicator 15 is displayed on the display screen so that the front end thereof is oriented to a direction of the center position of a cluster out of the display screen. A drawing control method of the direction indicator 15 will be briefly described below referring to FIG. 7A and FIG. 7B. A coordinate system shown in FIG. 7A and FIG. 7B is a coordinate system having an origin at the center of the display screen for representing each position within the display screen.

FIG. 7A schematically illustrates a positional relationship between the display area displayed in the display screen and a cluster A corresponding to a cluster out of display screen. When displaying the direction indicator 15 corresponding to the cluster A on the display screen as shown in FIG. 7A, the display format selection control section 103 specifies first a center position C (c_x, c_y) in the coordinate system for the display screen with respect to a cluster area of the cluster A. After that, the display format selection control section 103 assumes a straight line connecting between the origin and the center position C, and positions the direction indicator 15 on the straight line. At this time, the front end of the direction indicator 15 is preferably positioned at a intersection A (a_x, a_y) of the straight line connecting between the origin and the center position C and a boundary line of the display area as shown in FIG. 7A.

Also, the display format selection control section 103 changes the size of the direction indicator 15 in accordance with the distance between the center position (i.e. origin O) of the display screen and the cluster A as shown in FIG. 7B. In particular, the display format selection control section 103 increases the size of the direction indicator 15 as the distance to the cluster A gets smaller. With such display, the user is allowed to visually comprehend the distance between the cluster out of display screen corresponding to the direction indicator 15 and the center position of the display area.

The display position and the size of the direction indicator 15 are described referring to FIG. 7A and FIG. 7B. The label 13 is also displayed at a position that suggests a direction where the cluster A exists, and is preferably displayed with a size that suggests a distance to the cluster.

The display area is, for example, segmented into four partial areas by two straight lines each representing diagonal lines thereof as shown in FIG. 7A. Here, the cluster objects corresponding to each of the clusters out of display screen (label 13 and direction indicator 15) are desirably positioned within a partial area where the cluster is included. For example, the cluster object corresponding to the cluster A shown in FIG. 7 is preferably disposed in an area represented by y≧(height/width)x, and y≧−(height/width)x.

When displaying the label 13 including a character string as shown in FIG. 3 and FIG. 4, the display format selection control section 103 preferably displays the characters with a size that suggests a distance to the cluster out of the display screen. For example, when the distance to the cluster out of the display screen is large, the display format selection control section 103 preferably reduces the size of the characters, and when the distance to the cluster out of the display screen is small, preferably increases the size of the characters.

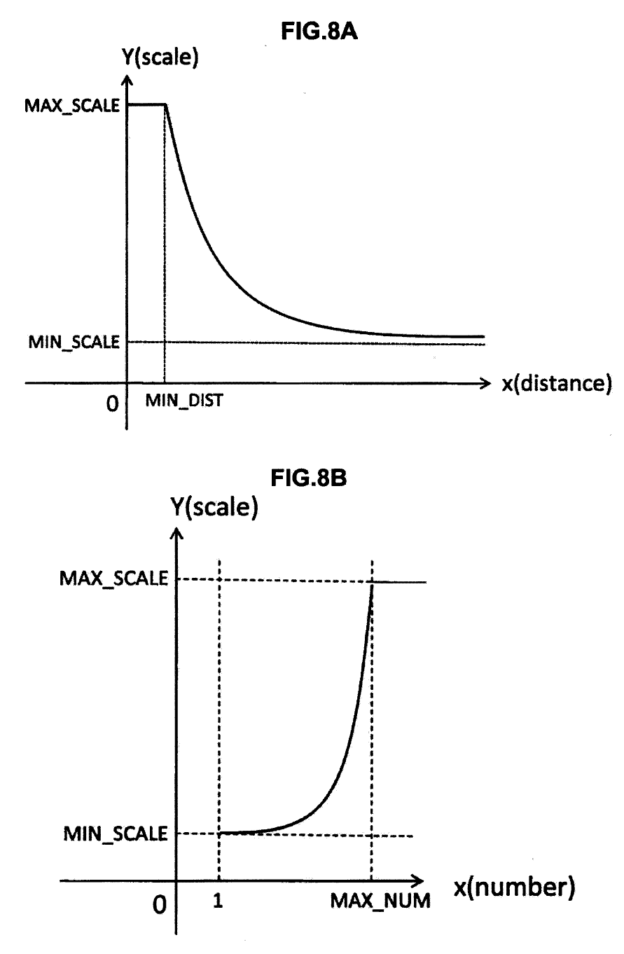

The display format selection control section 103 may determine particular size of the label 13 and the direction indicator 15 with an arbitrary method. However, the display format selection control section 103 may determine particular size by using, for example, a function as shown in FIG. 8A.

In the function shown in FIG. 8A, X-coordinate represents a pixel distance from the center position of the display screen to the cluster center, while Y-coordinate represents a display magnification of the label 13 and the direction indicator 15.

The display format selection control section 103 determines the display magnification Y using a formula 101 and a formula 102 below.

$$\begin{matrix} [ Formula 1 ] & \\ ( When X \geq MIN\_DIST ) \\ Y = ( MAX\_SCALE - MIN\_SCALE ) \times MIN\_DIST \times \frac{1}{X} + MIN\_SCALE & ( Formula 101 ) \\ ( When X < MIN\_DIST ) \\ Y = MAX\_SCALE & ( Formula 102 )\end{matrix}$$

As demonstrated in the above formulas, when the distance to the cluster center is smaller than a predetermined threshold value (MIN_DIST), the display format selection control section 103 changes the display magnification to a maximum value (MAX_SCALE); and when the distance to the cluster center is larger than or equal to a predetermined threshold value, the display format selection control section 103 changes the display magnification to be 1/X of the maximum value.

The display format selection control section 103 may determine particular size of the label 13 and the direction indicator 15 in accordance with the number of contents included in the focused cluster out of the display screen. In this case, the display format selection control section 103 may determine the particular size using the function shown in FIG. 8B.

In the function shown in FIG. 8B, X-coordinate represents the number of contents included in the focused cluster out of the display screen, while Y-coordinate represents display magnification of the label 13 and the direction indicator 15.

The display format selection control section 103 determines the display magnification Y using a formula 103 and a formula 104.

$$\begin{matrix} [ Formula 2 ] & \\ ( When 1 \leq X \leq MAX\_NUM ) \\ Y = \frac{( MAX\_SCALE - MIN\_SCALE )}{{( MAX\_NUM - 1 )}^{k}} \times {( X - 1 )}^{k} + MIN\_SCALE & ( Formula 103 ) \\ ( When MAX\_NUM < X ) \\ Y = MAX\_SCALE & ( Formula 104 )\end{matrix}$$

A parameter k in the above formula 103 is a factor which determines a slope of the function, and an arbitrary value may be set depending on the environment where the method is applied. As demonstrated in the above formulas, when the number of contents included in the cluster is 1, the display format selection control section 103 sets the display magnification to a minimum value (MIN_SCALE), and changes the display magnification based on the above formula 103 as the number of contents included in the cluster increases.

The display format selection control section 103 is capable of controlling for switching between display/non-display of the label 13 and direction indicator 15 of cluster shown in FIG. 3 and FIG. 4 in accordance with the preset initial setting value or user's operation and the like. By performing such switching control by the display format selection control section 103, the user is allowed to select a desired display format of the display screen (in more particularly, display format for information on clusters existing out of the display screen). As for the user's operation for switching between display/non-display of the label 13 and the direction indicator 15 may be appropriately set in accordance with the specifications of a particular information processor 10. As for examples of such switching operation, selection of object like icon and buttons, long-press on a touch panel, flick operation on a touch panel and the like are available.

The display format selection control section 103 according to the embodiment may display a distance to a cluster existing out of the display screen (separation distance from the display area) accompanying the label 13 and the direction indicator 15 of the cluster referring to a metadata as shown in FIG. 6 which is associated with a cluster selected by the node selecting section 107 described below. The object representing the distance to the cluster may be switched between display/non-display same as the label 13 and the direction indicator 15 of the cluster.

The above description describes an example in which the granularity of the cluster is determined according to the size of the feature space to be displayed on the display screen (for example, a reduction scale ratio for displaying a feature space or the like). However, the granularity of the cluster may be determined in accordance with, for example, an administrative district in a map displayed on the display screen, or may be determined while considering administrative district and reduction scale ratio respectively.

The display control section 105 includes, for example, a CPU, a ROM, a RAM, a communicating device, an output device and the like. The display control section 105 controls a display on a display screen of a display device such as a display provided to the information processor 10, or a display device such as a display which is externally connected to the information processor 10. The display control section 105 controls the display on a display screen based on user's operation information notified from the user operation information generating section 101 or the information on a display format of the display screen notified from the display format selection control section 103.

The node selecting section 107 includes, for example, a CPU, a ROM, a RAM and the like. The node selecting section 107 uses a previously generated tree structure to select a node which satisfies predetermined conditions from the nodes included in the tree structure in accordance with the size of the displayed feature space which is a feature space displayed on the display screen. In further particular, the node selecting section 107 selects a node (i.e. cluster) which is used for controlling a display format of the display screen based on the information on a feature space to be displayed on the display screen notified from the display format selection control section 103 and the information on the granularity of the cluster to be displayed on the display screen.

The node selecting section 107 selects a node by focusing not to a point but to an area which is displayed on the display screen. In more particularly, the node selecting section 107 adjusts the granularity of the cluster included in the display area to a same hierarchy, and as for the clusters existing out of the display screen, selects the clusters so that the granularity of the clusters gets larger as the distance is separated further away from the display area corresponding to the display screen.

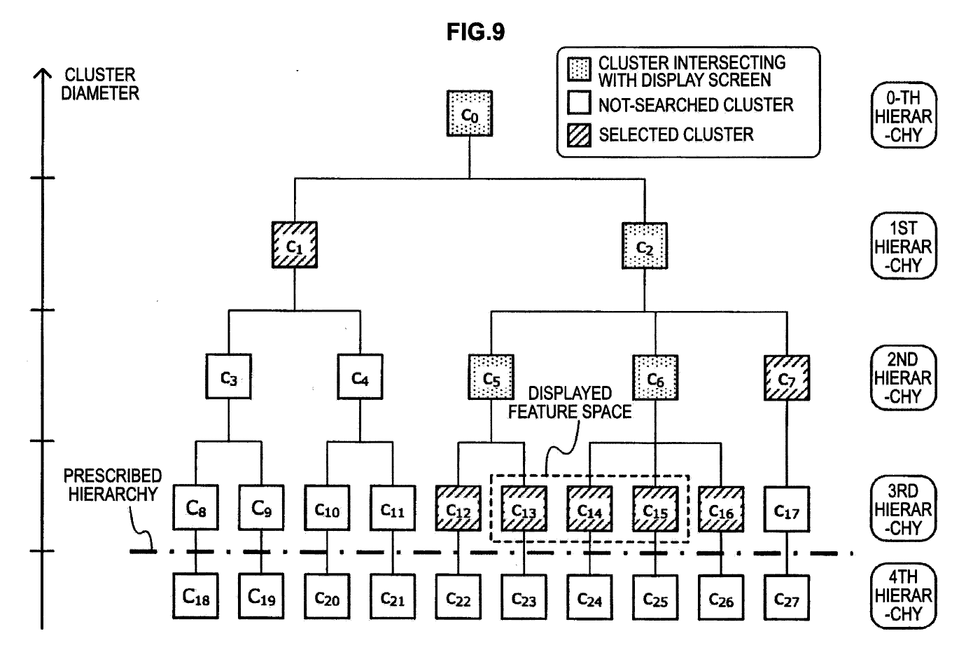

Now, referring to FIG. 9, processing of node selection (processing of cluster selection) in the node selecting section 107 according to the embodiment will be particularly described.

In particular, the node selecting section 107 refers to the information on the feature space to be displayed on the display screen notified from the display format selection control section 103 and specifies the size of the feature space to be displayed on the display screen and the reduction ratio (or magnification ratio) for displaying the feature space on the display screen. If a piece of information with which the size of the feature space to be displayed on the display screen and the reduction ratio can be calculated based on an actual size of the display screen are included, the information on the feature space to be displayed on the display screen may not include both of the information on the size of the feature space to be displayed on the display screen and the reduction ratio.

The tree structure used in the information processor 10 according to the embodiment is configured so that the clusters included in a same hierarchy level have a relationship with respect to the granularity of the clusters (in more particular, to have granularity of the clusters that is similar to one another) as shown in FIG. 9. When the information on the granularity of the clusters to be displayed on the display screen is obtained from the display format selection control section 103, the node selecting section 107 uses the obtained information on the granularity of the cluster to determine the hierarchy in the tree structure at which nodes are searched for. In particular, after specifying the granularity of the notified cluster, the node selecting section 107 determines a range of the hierarchies at which the nodes are searched for from a hierarchy including the route node to a hierarchy relevant to the granularity of the notified cluster (in the case shown in FIG. 9, 0-th hierarchy to third hierarchy).

Then, the node selecting section 107 determines whether any cluster intersects with the feature space corresponding to the display screen from the route node in order using the metadata associated with the cluster as shown in FIG. 6 and known information on the size of the feature area to be displayed on the display screen. When any cluster that does not intersect with the feature space corresponding to the display screen is found, the node selecting section 107 selects the cluster as a cluster to be used by the display format selection control section 103.

When any cluster that intersects with the feature space corresponding to the display screen is found, the process is repeated recursively on the clusters corresponding to the child nodes of the cluster. That is, the node selecting section 107 determines whether any cluster corresponding to the child node of the focused cluster intersects with the feature space corresponding to the display screen.

When the hierarchy of the focused cluster (node) reaches the hierarchy (prescribed hierarchy) corresponding to the granularity of the cluster notified from the display format selection control section 103, the node selecting section 107 selects all focused clusters in the focused hierarchy without searching for the layer (leaf node side) lower than the focused hierarchy as the clusters used by the display format selection control section 103.

Referring to FIG. 9, processing of node selection by the node selecting section 107 will be particularly described below. In the following description, the third hierarchy shown in FIG. 9 is assumed as a prescribed hierarchy.

First of all, the node selecting section 107 refers to a metadata associated with a route node c₀ and determines whether the route node c₀ intersects with the feature space (hereinafter, referred to also as displayed feature space) corresponding to the display screen. In the example shown in FIG. 9, since the route node c₀ intersects with the displayed feature space, the node selecting section 107 selects a node c₁ and a node c₂ included in the first hierarchy as the objects to be searched for.

In this case, it is assumed that the node c₁ does not intersect with the displayed feature space, and the node c₂ intersects with the displayed feature space. In this case, the node selecting section 107 selects a cluster corresponding to the node c₁ as a cluster to be used by the display format selection control section 103, and selects nodes c₅-c₇ corresponding to the child node of the node c₂ as the objects to be searched for.

Here, it is assumed that the node c₅ and the node c₆ intersect with the displayed feature space, while a node c₇ does not intersect with the displayed feature space. In this case, the node selecting section 107 selects the cluster corresponding to the node c₇ as a cluster to be used by the display format selection control section 103, and selects nodes c₁₂-c₁₆ corresponding to the child node of the node c₅ and node c₆ as the objects to be searched for.

Although the nodes c₁₂-c₁₆, are the targets to be processed next, since the nodes c₁₂-c₁₆ are included in the third hierarchy which is the prescribed hierarchy, the node selecting section 107 selects the nodes c₁₂-c₁₆ which are all cluster focused in the focused hierarchy as the cluster to be used by the display format selection control section 103.

As a result of the search processing as described above, the nodes c₁, c₇, and c₁₂-c₁₆ are finally selected as the clusters to be used by the display format selection control section 103.

Since the prescribed hierarchy is determined based on the granularity of the cluster to be displayed on the display screen, a part of the selected clusters included in the prescribed hierarchy is included in the displayed feature space. In the example shown in FIG. 9, the clusters corresponding to the nodes c₁₃-c₁₅ are displayed at the substantially same granularity of the cluster in the display screen. As demonstrated in FIG. 9, the clusters which are located out of the display screen are the clusters each corresponding to the node c₁₂, node c₁₆, node c₇, and node c₁, the granularity of the clusters thereof gets larger as the location separates further away from the display screen (displayed feature space). When the clusters out of the displayed feature space are intended to display without using the selecting technique of the clusters according to the embodiment, for example, the direction indicators corresponding to the clusters c₈-c₁₂ and clusters c₁₆-c₁₇ shown in FIG. 9 are displayed within the display screen and may cause the display screen to be cluttered. However, by using the selecting technique of the clusters as described above, since the clusters located far away from the displayed feature space are grouped into a large granularity of the cluster, the number of the cluster objects (label 13 and direction indicator 15) displayed on the display screen is prevented from increasing.

The node selecting section 107 notifies the information representing the nodes (clusters) which are selected in the above-described processing to the display format selection control section 103.

The storage 109 is an example of a storage device provided to the information processor 10 according to the embodiment. The storage 109 may store various kinds of content data stored in the information processor 10 and metadata associated with the content data or the like. The storage 109 may also store tree structure data corresponding to a tree structure which is generated by the tree structure generating section 111 described below or an external information processor. Further, the storage 109 may store application data corresponding to various kinds of applications which are used by the display format selection control section 103 and the display control section 105 to display various kinds of information on the display screen. Furthermore, the storage 109 appropriately stores various parameters and processing in progress necessary to be stored for the information processor 10 to carry out some kind of processing, or various kinds of database. The storage 109 allows the processing sections included in the information processor 10 according to the embodiment to freely write thereon and read therefrom.

The tree structure generating section 111 includes, for example, a CPU, a ROM, a RAM and the like. The tree structure generating section 111 assumes that a feature space is prescribed by using a feature quantity as described above. A tree structure representing a result of clustering of contents is generated in accordance with the distribution of contents within the feature space.

The tree structure generating section 111 generates a tree structure described above in a manner, for example, as described below.

First of all, the tree structure generating section 111 refers to a piece of metadata in which the information processor 10 is associated with usable content data to arrange the content data on a plane within the feature space based on the positional information prescribed in the metadata. Note that arrangement of the contents is virtual arrangement.

Then, the tree structure generating section 111 calculates the distance among the data with respect to a set of content data included in the plane. Subsequently, the tree structure generating section 111 collects a plurality of data which are included in a close distance into a group (classification). Such grouping processing made by the tree structure generating section 111 is the clustering. Each of the groups collected by the grouping processing (clustering) is the cluster.

The tree structure generating section 111 performs coupling or separating of clusters to classify the contents usable by the information processor 10 into a plurality of clusters and generates a tree structure of multi-hierarchy, in which content data is the leaf node and the clusters are the node respectively.

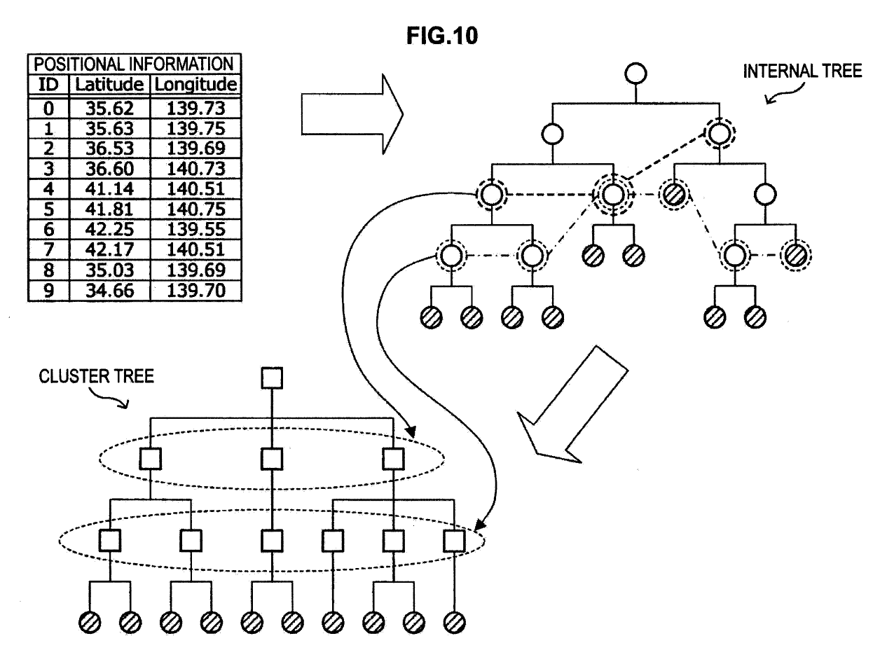

Referring to FIG. 10-FIG. 15, an example of the clustering method made by the tree structure generating section 111 will be briefly described.

The tree structure generating section 111 according to the embodiment performs the clustering method according to a flow shown in FIG. 10. The tree structure generating section 111 first refers to the positional information associated with content data to generate a tree structure, which is referred to as internal tree shown upper-right in FIG. 10. Subsequently, the tree structure generating section 111 reconfigures the generated internal tree based on a predetermined condition to generate a cluster tree shown in lower portion in FIG. 10.

In FIG. 10, as an example of the positional information associated with the content data, positional information in which degrees of latitude and longitude are used is given. In FIG. 10, items marked with a shadowed circle correspond to the content data, and the circle represents a node (cluster) in the internal tree. Item marked with a box represents a node of the tree structure generated by the tree structure generating processing of the tree structure generating section 111.

The processing to generate an internal tree will be described first.

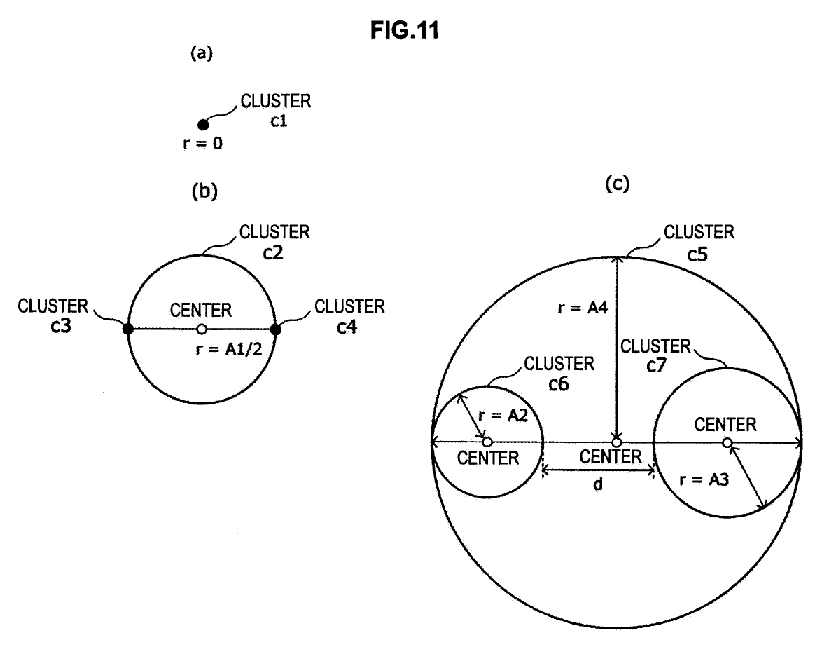

FIG. 11 is an illustration for explaining the cluster generating method. FIG. 11(a) illustrates a case where a cluster c1 includes one content; FIG. 11(b) illustrates a case where a cluster c2 includes two clusters; and FIG. 11(c) illustrates a case where a cluster c5 includes at least four clusters.

In FIG. 11(b), the cluster c2 is a cluster which includes clusters c3 and c4 each including a single content. In FIG. 11(c), the cluster c5 is a cluster which includes clusters c6 and c7 each having at least two or more contents. In the following description, an example of clustering of contents arranged in a two-dimensional plane is given.

Each of the clusters generated by clustering a plurality of contents has a circular area which has a center position (center) and a radius of the circle as attribute values. Thus, a cluster area which has a circular shape defined by a center and a radius includes contents therein.

For example, in the case where the cluster c1 includes only one content as shown in FIG. 11(a), the center position of the cluster c1 is the position of a content included in the cluster c1. Since the cluster c1 includes only one point, the radius of the cluster c1 is 0 (r=0).

For example, when the cluster c2 includes two contents (cluster c3 and c4) as shown in FIG. 11(b), the center position of the cluster c2 is positioned on a straight line which connects the positions of the two contents, and the precise position is the center of the straight line. The radius of the cluster c2 is a half of the straight line connecting the positions of the two contents. For example, when the distance of the straight line connecting the clusters c3 and c4 corresponding to the two contents is A1, the radius r of the cluster c2 is A1/2.

For clustering, when calculating the distance between the clusters each of which includes only one content, the distance between the contents is calculated. For example, when calculating the distance between the cluster c3 and the cluster c4, the distance between the position of the content included in the cluster c3 and the position of the content included in the cluster c4 is calculated.

Also, it is assumed that, for example, a cluster c5 includes at least four or more contents as shown FIG. 11(c). In this case, the center position of the cluster c5 is on a straight line connecting a center position of a cluster c6 and a center position of a cluster c7 as well as at the center of a straight line connecting a point where a circle of the cluster c5 and a circle of the cluster c6 are in contact with each other and a point where a circle of the cluster c5 and a circle of the cluster c7 are in contact with each other. The radius of the cluster c5 is a half of a value of the straight line connecting the points where the circle of the cluster c5 is in contact with the circles of the clusters c6 and c7.

For clustering, when calculating the distance between clusters including plural contents, a shortest distance between the circumferences of circles of the respective clusters is calculated. For example, the distance between the cluster c6 and the cluster c7 is a distance d shown in FIG. 11(c). Defining the radius of the cluster c6 as A2; the radius of the cluster c7 as A3; and the radius of the cluster c5 as A4, the distance d between the cluster c6 and the cluster c7 is 2 (A4-A2-A3).

The calculation method for the distance between the clusters used by the tree structure generating section 111 according to the embodiment is not limited to the above-described method, and any arbitrary method such as a centroid method, a shortest distance method, a maximum distance method, an inter-group distance method, and a ward method may be used.

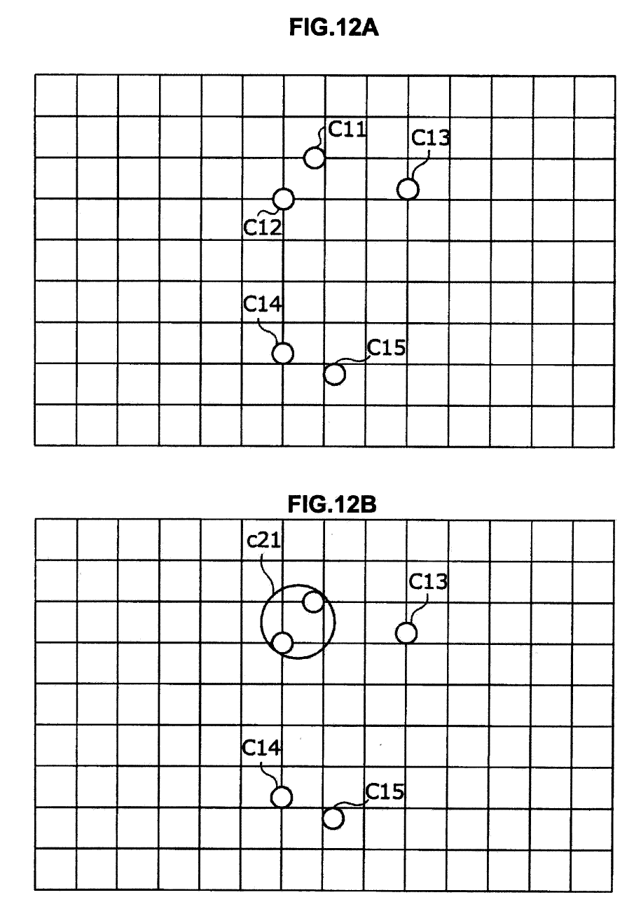

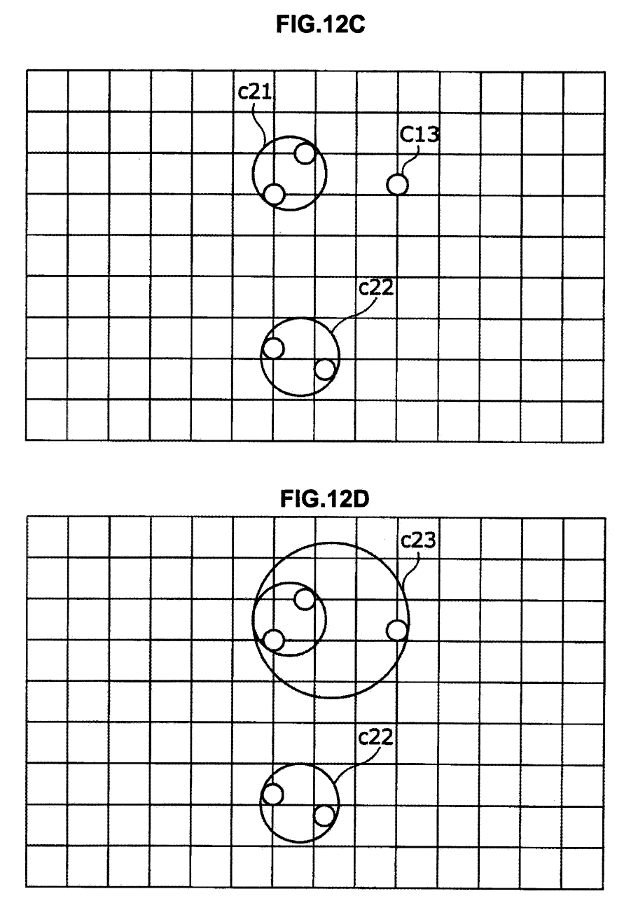

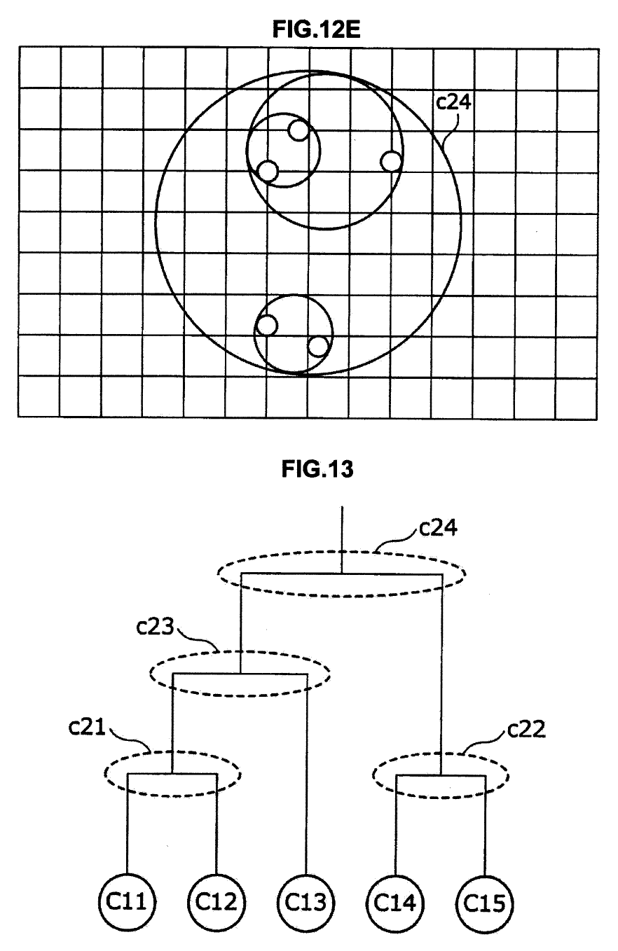

Subsequently, referring to FIG. 12A-FIG. 13, an illustrative example of a clustering processing made by the tree structure generating section 111 will be described. FIG. 12A-FIG. 13 are illustrations for explaining the cluster generating method (in more particularly, generating method of the internal tree). FIG. 12A-FIG. 13 illustrates a case of clustering of five contents C11-C15.

The tree structure generating section 111 refers to the positional information associated with the five contents C11-C15 first, and arranges the contents in a plane on a feature space (FIG. 12A). Then, the tree structure generating section 111 calculates the distance between the contents. Based on the calculation result, the tree structure generating section 111 integrates a content C11 and a content C12, the distance therebetween is the shortest, into one group of cluster c21 (FIG. 12B). The tree structure generating section 111 determines so that the cluster c21 includes all of the content C11 and the content C12 which are the elements of the cluster c21.

The tree structure generating section 111 carries out the processing in the same manner to integrate a content C14 and a content C15, since the distance therebetween is the next shortest, into one group of cluster c22 (FIG. 12C). In this case also, the tree structure generating section 111 determines so that the cluster c22 includes all of the content C14 and the content C15 which are the elements of the cluster c22.

Subsequently, the tree structure generating section 111 calculates the distances between the generated two clusters c21 and c22 and a remaining content C13 respectively. In the case shown in FIG. 12C, the distance between the cluster c21 and the content C13 is shorter than the distance between the cluster c22 and the content C13. Therefore, the tree structure generating section 111 integrates the cluster c21 and the content C13 into one group of a cluster c23 (FIG. 12D). In this case also, the tree structure generating section 111 determines so that the cluster c23 includes all of the cluster c21 and the content C13.

Finally, the tree structure generating section 111 integrates the remaining two clusters c22 and c23 into one group of a cluster c24 (FIG. 12E). In this case also, the tree structure generating section 111 determines so that the cluster c24 includes all of the cluster c22 and the cluster c23. For example, the tree structure generating section 111 may determine so that the cluster c24 is a circumcircle of the two circles representing the cluster c22 and the c23.

As described above, the tree structure generating section 111 makes the clustering of the contents C11-C15 in order to generate the clusters c21-c24. Also, the tree structure generating section 111 generates a tree structure (clustering tree diagram) based on the generated clusters c21-c24. FIG. 13 shows a tree structure thus generated.

When each of the contents C11-C15 is handled as a leaf node, each of the clusters generated by the tree structure generating section 111 forms a tree structure as shown in FIG. 13. For example, in FIG. 12B, it has been described that the cluster c21 is the cluster that includes all of the content C11 and the content C12. Such inclusion relation corresponds to the fact that, in FIG. 13, two branches extend from the cluster c21, and the content C11 and the content C12 are the child nodes of the cluster c21. Likewise, for example, in FIG. 12E, it has been described that the cluster c24 is the cluster that includes all of the cluster c22 and the cluster c23. Such inclusion relation corresponds to the fact that, in FIG. 13, two branches extend from the cluster c24, and the cluster c22 and the cluster c23 are the child nodes of the cluster c24.

As demonstrated in FIG. 12E and FIG. 13, the finally generated cluster c24 includes all contents (i.e. all leaf nodes) and all clusters (i.e. nodes). Therefore, the cluster c24 is the cluster that corresponds to a route node in the tree structure.

Using the illustrative examples, the generating processing of the internal tree made by the tree structure generating section 111 has been described.

After completing generating processing of the internal tree, the tree structure generating section 111 subsequently carries out generating processing of a cluster tree as described below.

When carrying out the generating processing of the internal tree as shown in FIG. 12A-FIG. 12E and the generating processing of the cluster tree described below, it is preferred to appropriately calculate the center position of the cluster and distance between the clusters. The tree structure generating section 111 according to the embodiment may use arbitrary method to calculate the information; for example, following method may be used.

For example, when there are n of content data, the tree structure generating section 111 sets clusters so that each cluster includes data as one element to create total n of clusters. Each cluster has the center C and the radius r as the attribute values, the initial value of the center C is a coordinate value of the data, and the initial value of the radius r is 0.

Then, the tree structure generating section 111 determines the cluster center C and the radius r so that the distance from the cluster center C to each element is radius r or less on all elements included in the cluster. With this, all elements included in the cluster are included inside a sphere defined by the center C and the radius r.

Subsequently, tree structure generating section 111 determines the distance between the clusters, for example, as described below.

When integrating a cluster i and a cluster j to create a cluster k, the tree structure generating section 111 calculates a distance d(i, j) between the cluster i and the cluster j by using formula III and formula 112.

d(i,j)=r(k)−r(i)−r(j)(r(k)≧r(i)+r(j)) (Formula 111)

d(i,j)=0(r(k)<r(i)+r(j)) (Formula 112)

In the above formula III and formula 112, r(i) represents the radius of the cluster i. As demonstrated by the above formula 101 and formula 102, the distance d between the clusters is equivalent to an increase of the radius when the clusters are integrated.

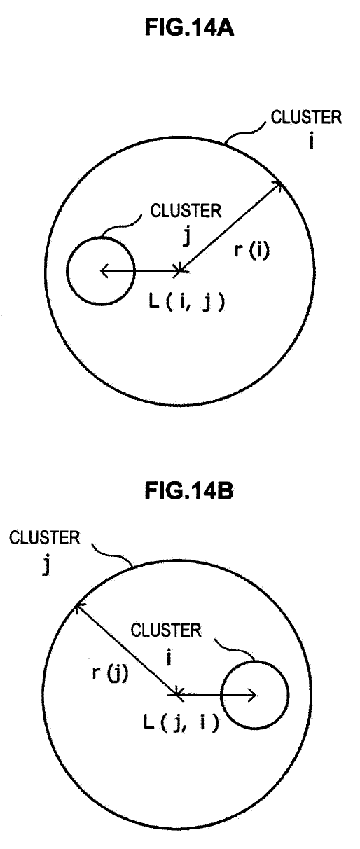

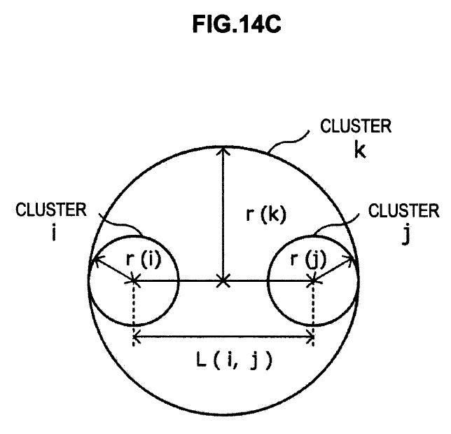

Subsequently, referring to FIG. 14A-FIG. 14C, a method to calculate the center and radius of a cluster after two clusters are integrated will be briefly described. FIG. 14A-FIG. 14C illustrate an inclusion relation of elements included in each cluster when two clusters are integrated.

When integrating two clusters, the tree structure generating section 111 classifies into three patterns (1)-(3) below depending on the inclusion relation of elements included in the clusters.

(a) m(i)⊃m(j)
(b) m(j)⊃m(i)

### (c) Otherwise

Here, m(i) represents a set of all elements included in the cluster i; and m(j) represents a set of all elements included in the cluster j.

A case of (a) above is a state that all elements included in the cluster j are included in the cluster i as shown in FIG. 14A. A case of (b) above is a state that all elements included in the cluster i are included in the cluster j as shown in FIG. 14B. A case of (c) above is a state other than case (a) and case (b); for example, inclusion relation of the cluster i and the cluster j is a state shown in FIG. 14C.

The tree structure generating section 111 determines the respective cases of (a)-(c) based on the coordinate of the center and the radius of the cluster i and the cluster j respectively.

For example, when a sphere of the cluster i, the radius of which from the coordinate C(i) of the center is r(i), includes all of the cluster j of a sphere having the coordinate C(j) of the center and the radius r(j), the tree structure generating section 111 determines that the case (a) shown in FIG. 14A is established.

In other word, when r(i)≧(j)+l(i, j), the tree structure generating section 111 determines that the case (a) above is established. Here, l(i, j) represents a Euclidean distance between the centers of the cluster i and the cluster j as expressed by formula 113 below.

l(i,j)=|C(i)−C(j)| (Formula 113)

Defining the dimension of the data as dim, l(i, j) is expressed by formula 114 below. Here, in the formula 114 below, c(i, k) indicates a value of the k-th attribute representing center value of the cluster i.

$$\begin{matrix}[ Formula 3 ] & \\ l ( i , j ) = \sqrt{{\sum }_{k = 1}^{dim} {( c ( i , k ) - c ( j , k ) )}^{2}} & ( Formula 114 )\end{matrix}$$

When the case (a) above is established, the tree structure generating section 111 uses the cluster i as it is as the center and the radius of the cluster k after integration.

The case (b) above is equivalent to the case (a) in which index “i” and “j” are exchanged with each other; the tree structure generating section 111 carries out the processing in the same manner as the case (a) above.

When the case (c) above is established, the tree structure generating section 111 generates a cluster k as a minimum sphere that includes a sphere of the cluster i and a sphere of the cluster j as shown in FIG. 14C. The tree structure generating section 111 calculates the radius of the cluster k using formula 115 below. Also, the tree structure generating section 111 calculates the center of the cluster k using formula 116 below. Here, the center of the cluster k is positioned on a straight line which connects between the center C(i) of the cluster i and the center C(j) of the cluster j.

r(k)=(l(i,j)+r(i)+r(j))/2 (Formula 115)

C(k)=[(r(i)−r(j)+l(i,j))*C(i)+(r(j)−r(i)+l(i,j))*C(j)]/(2*l(i,j)) (Formula 116)

The tree structure generating section 111 determines the distance between the clusters and the center of the cluster by using the method described above.

The tree structure generating section 111 determines the center (center position) and the radius of the cluster, which are calculated as describe above, as the attribute values unique to the cluster included in the cluster data shown in FIG. 6. The tree structure generating section 111 carries out the generating processing of a cluster tree described below by using the attribute values unique to the respective clusters included in the internal tree. Also, the node selecting section 107 can easily determine whether the cluster intersects with the displayed feature space by comparing the attribute values of the clusters included in the cluster tree with the positional information corresponding to an arbitrary point. If all of certain cluster area is included in the cluster area of its parent cluster, the attribute values (center position and radius) of the parent cluster indicate a range of all elements included in the cluster. Therefore, the display format selection control section 103 and the node selecting section 107 can easily associate the clusters with the elements displayed on the display screen.

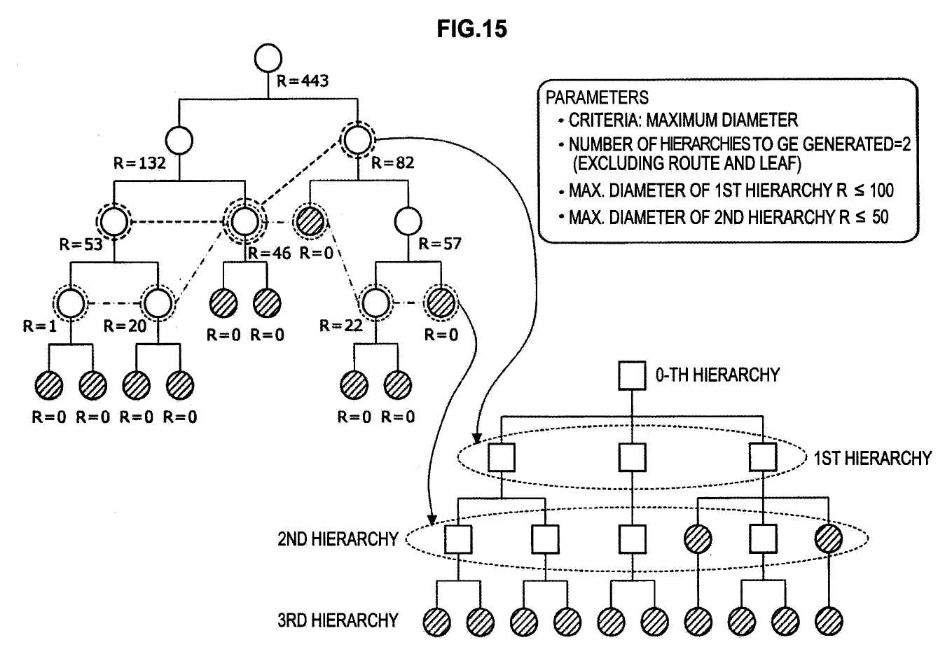

Subsequently, referring to FIG. 15, the generating processing of the cluster tree made by the tree structure generating section 111 will be briefly described. FIG. 15 is an illustration for explaining the cluster generating method (in more particularly, generating method of cluster tree).

The generating processing of a cluster tree based on the internal tree is made based on the parameter shown in FIG. 15. In FIG. 15, as the parameters used for the generating processing of the cluster tree, the following parameters are set: (A) feature quantity of the cluster to be focused; (B) a number of hierarchies to be generated in addition to the hierarchy to which the route node is included and the hierarchy to which the leaf nodes are included; and (C) conditions of the granularity of the cluster for each hierarchy. In particular, in FIG. 15, (A) based on the maximum diameter of the cluster; (B) two hierarchies are to be generated between the hierarchy to which the route node is included and the hierarchy to which the leaf nodes are included; and (C) maximum diameter R≦100 for the first hierarchy and maximum diameter R≦50 for the second hierarchy are set.

The tree structure generating section 111 traces the tree structure in order from the route node of the generated internal tree, and specifies a node which satisfies the conditions with respect to the first hierarchy. Then, with respect to the respective branches to which the specified node is included, the tree structure generating section 111 determines the uppermost node that satisfies the conditions as the node included in the first hierarchy. As a result, in the example shown in FIG. 15, three nodes which are connected to each other with a thick dot line (from the left in order, a node of R=53, a node of R=46 and a node of R=82) are selected as the nodes included in the first hierarchy.

Likewise, the tree structure generating section 111 traces the tree structure from the route node of the generated internal tree in order, and specifies the nodes that satisfy the conditions with respect to the second hierarchy. Then, with respect to the respective branches to which the specified node is included, the tree structure generating section 111 determines the uppermost node that satisfies the conditions as the node included in the second hierarchy. As a result, in the example shown in FIG. 15, six nodes which are connected to each other with a thin dot line (from the left in order, a node of R=1, a node of R=20, a node of R=46, 7-th content data from the left, a node of R=22, content data at rightmost) are selected as the nodes included in the second hierarchy.

By carrying out the processing as described above, the tree structure generating section 111 generates the cluster tree shown at the right in FIG. 15.

After generating the cluster tree of usable contents for the information processor 10, the tree structure generating section 111 associates the generated clusters with metadata as shown in FIG. 6. The tree structure generating section 111 terminates the clustering processing, and stores the generated tree structure data and the cluster data representing the tree structure in the storage 109 or the like while associating the cluster data with the generated clusters.

The tree structure generating section 111, which the information processor 10 according to the embodiment may include therein, has been described.

An example of function of the information processor 10 according to the embodiment has been described above. The above-described component elements may include a general purpose unit or circuit, or hardware each specialized to the functions of the component elements. Or a CPU or the like may perform every function of the component elements. Therefore, the applied configuration may be appropriately changed in accordance with the technical art at the point when the embodiment is implemented.

A computer program for achieving the functions of the above-described information processor according to the embodiment may be created and mounted on a personal computer or the like. A computer readable record medium which stores such computer program may be provided. For example, a magnetic disk, an optical disk, a magnetic optical disk, a flash memory and the like are available for the record medium. The above-described computer program may be delivered via, for example, a network without using any record medium.

In the above description, an example is given, in which, as a feature quantity which characterizes the feature space, degrees of latitude and longitude are used to specify a position on the earth surface, and a map plane on which the earth surface is extended in two-dimensional plane is displayed on the display screen. Therefore, in the above description, the displayed feature space has a generally a rectangular shape as a map range which is included in the display screen. However, for example, when considering a case where a three-dimensional feature space having a width direction, a height direction and a depth direction is displayed on the display screen, it is clear when considering, for example, a picture drawn using perspective method, that a three-dimensional image which has values in the width direction and the height direction being substantially the same size as those of the display screen and unlimited depth, is displayed in the display screen. In such case, the displayed feature space may be appropriately prescribed. For example, three-dimensional object, which has a predetermined length from the display screen toward the depth direction (in other word, a limited length in which a position far away in the depth direction is not considered), may be preferably used as a displayed feature space.

### <Flow of Information Processing Method>

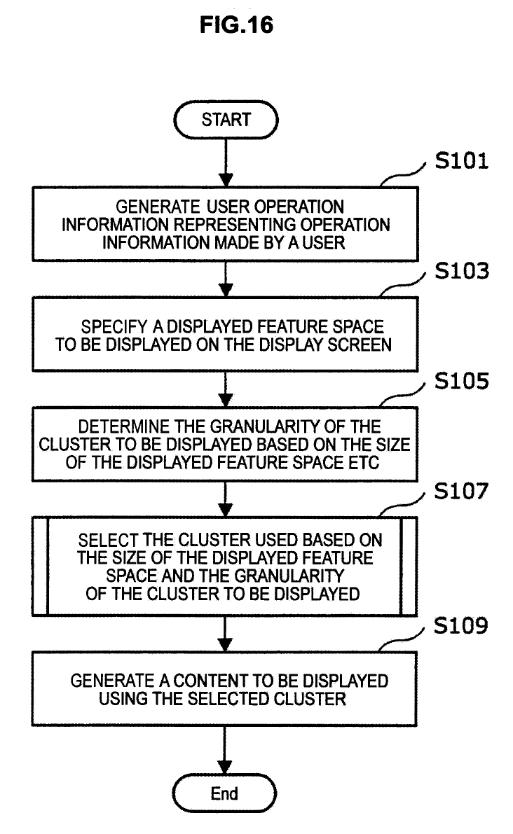

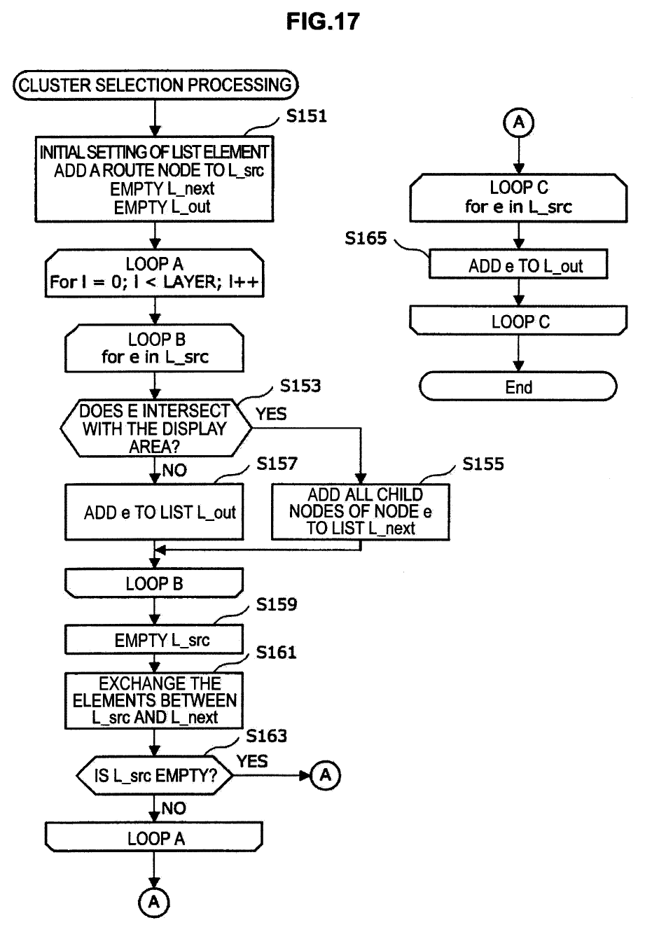

Now, referring to FIG. 16 and FIG. 17, a flow of an information processing method according to the embodiment will be described. FIG. 16 and FIG. 17 are flow diagrams each showing an example of a flow of the information processing method according to the embodiment.

### [Entire Flow]

Referring to FIG. 16, entire flow of the information processing method according to the embodiment will be described first.

First, the user operation information generating section 101 of the information processor 10 obtains a signal made by user's operation from various kinds of input devices, and generates user's operation information representing operation information made by a user (step S101), and outputs the signal to the display format selection control section 103 and the display control section 105.

Based on the user's operation information notified from the user operation information generating section 101, the display format selection control section 103 specifies a feature space to be displayed on the display screen (displayed feature space) (step S103). With this, the size of the displayed feature space and a reduction scale ratio (or magnification ratio) for displaying the displayed feature space on the display screen are specified.

Subsequently, the display format selection control section 103 determines the granularity of the cluster to be displayed on the display screen based on the size of the specified displayed feature space and the reduction scale ratio (step S105). Then, the display format selection control section 103 outputs various kinds of information on the displayed feature space and the information on the granularity of the cluster to be displayed in the display screen to the node selecting section 107.

The node selecting section 107 refers to the previously generated tree structure and the metadata associated with the cluster, and selects the cluster used for processing by the display format selection control section 103 based on the size of the displayed feature space, the reduction scale ratio and the granularity of the cluster to be displayed (step S107). After the display format selection control section 103 selects the cluster used for processing, the node selecting section 107 outputs the information on the selected cluster to the display format selection control section 103.

The display format selection control section 103 refers to the information on the cluster notified from the node selecting section 107, and generates a content to be displayed using the selected cluster (step S109). In particular, the display format selection control section 103 causes the cluster positioned within the display screen among the selected clusters to be displayed within the display screen. Also, as for the cluster positioned out of the display screen among the selected cluster, the display format selection control section 103 causes the cluster object such as the label 13 and the direction indicator 15 to be displayed within the display screen. With this, the granularity of the clusters existing within the display screen is adjusted to a same level, and as for the clusters positioning out of the display screen, cluster objects which suggest the existence of the clusters positioning out of the display screen are displayed within the display screen.

### [Flow of Processing of Cluster Selection]

Now, referring to FIG. 17, a flow of the processing of cluster selection according to the embodiment will be described below.

When the display format selection control section 103 requests start of processing of node (i.e. cluster) selection, the node selecting section 107 sets the values of parameters (parameter LAYER in FIG. 17) that prescribe the hierarchy to be searched for in the tree structure first based on the information on the granularity of the cluster notified from the display format selection control section 103. Also, the node selecting section 107 sets the values of the parameters prescribing the displayed feature space (hereinafter, simply referred to as display area) based on the information on the displayed feature space notified from the display format selection control section 103.

Subsequently, the node selecting section 107 sets initial setting of elements in the list used for processing of node selection (step S151).

In particular, the node selecting section 107 makes initial setting of three kinds of lists of L_src, L_next and L_out. Here, the list L_src is a list which stores values indicating the node focused in the node search processing as elements; the list L_next is a list which stores values indicating the node to be focused in the following series of processing as elements; and the list L_out is the list which stores values indicating the selected node as elements. The node selecting section 107 adds a route node to the list L_src and eliminates the information from the lists L_next and L_out.

In a repetitive processing of “loop A” shown in FIG. 17, the node selecting section 107 sets 0 to the value of parameter 1 representing the hierarchy of the focused tree structure, and during parameter 1<LAYER is established, repeats the processing step S153 to step S163 described below. The repetitive processing represented by “loop A” includes a repetitive processing “loop B” of step S153 to step S157 and processing of step S159 to step S163.

In the repetitive processing “loop B” shown in FIG. 17, the node selecting section 107 carries out the processing described below on a node (represented by parameter e) stored in the list L_src. That is, the node selecting section 107 determines whether the relevant node intersects with the display area on the node (focused node) represented by the parameter e (step S153). When the focused node represented by the parameter e intersects with the display area, the node selecting section 107 adds all child nodes of the node e to the list L_next (step S155). When the focused node represented by the parameter e does not intersect with the display area, the node selecting section 107 adds the node e to the list L_out (step S157).

When the processing on every node e stored in the list L_src has completed, the node selecting section 107 terminates the repetitive processing “loop B”, and deletes the content (element) of the list L_src (step S159). Subsequently, the node selecting section 107 exchanges the elements of the list L_src and the elements of the list L_next (step S161). Then, the node selecting section 107 determines whether the elements of the list L_src is empty (step S163).

When the element of the list L_src is empty, the node selecting section 107 suspends the repetitive processing of “loop A”, and carries out the repetitive processing “loop C” described below. When the element of the list L_src is not empty, the node selecting section 107 increases the value of the parameter LAYER by 1, and continues the repetitive processing of “loop A”.

In step S153, when the value of the list L_src is empty, or when the repetitive conditions of “loop “A” is not satisfied, the node selecting section 107 carries out the repetitive processing “loop C”. The repetitive recessing “loop C” is carried out on every node e stored as the elements of the list L_src.

In particular, the node selecting section 107 adds a value representing the focused node e as an element of the list L_out (step S165). After carrying out the processing at step S165 on every node e stored as the elements of the list L_src, the node selecting section 107 terminates the repetitive processing represented by “loop C”, and terminates the processing of node selection.

By carrying out the processing of node selection in the flow as described above, the node selecting section 107 selects, for example, nodes shown in FIG. 9 as the nodes (clusters) used by the display format selection control section 103 for processing.

The flow of the information processing method according to the embodiment has been described above while referring to FIG. 16 and FIG. 17.

### <First Modification>

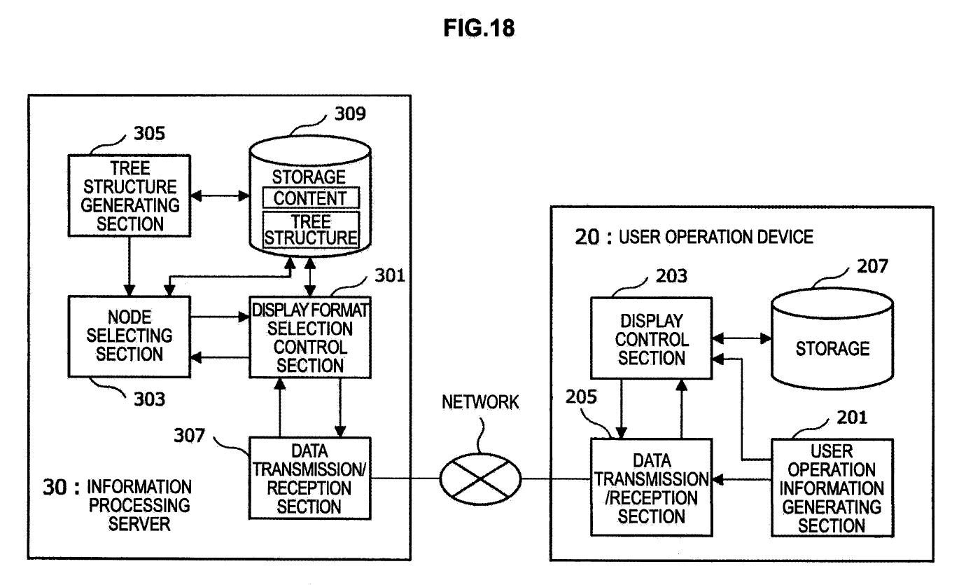

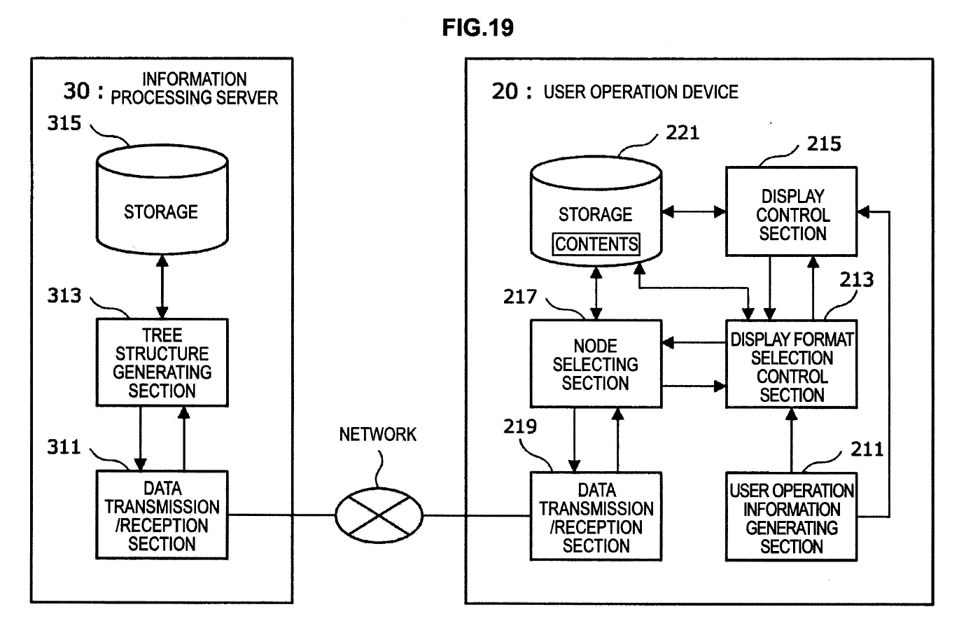

Now, a first modification of the information processor 10 according to the embodiment will be briefly described referring to FIG. 18 and FIG. 19. FIG. 18 and FIG. 19 are block diagrams each showing an example of the configuration of an information processing system which is capable of achieving the functions of the information processor 10 according to the embodiment.

FIG. 5 shows an example in which the function of the information processor 10 according to the embodiment is achieved within a certain apparatus. However, for example, as shown in FIG. 18, the function of the information processor 10 according to the embodiment described referring to FIG. 3-FIG. 15 may be achieved by a collaboration with a plurality of devices connected with each other via various kinds of network, or a plurality of devices connected directly to each other.

An information processing system according to the modification achieves the functions of the information processor 10 according to the embodiment by a user operation device 20 and an information processing server 30 which are connected to each other via a network as shown in FIG. 18 and collaborate with each other.

The user operation device 20 includes mainly a user operation information generating section 201, a display control section 203, a data transmission/reception section 205 and storage 207 as shown in FIG. 18 as an example.

The user operation information generating section 201 has the same function as that of the user operation information generating section 101 included in the information processor 10 according to the embodiment shown in FIG. 5 excepting a point that the generated user's operation information is outputted to the information processing server 30 via a data transmission/reception section 205 described below. Since the same effect is obtained, detailed description is omitted here.

The display control section 203 controls the display using information outputted from the information processing server 30 received by the data transmission/reception section 205 described below. The display control section 203 outputs the information used for specifying the size of the feature space to be displayed on the display screen such as the size of the display screen to the information processing server 30 via data transmission/reception section 205 described below. As for other points, the display control section 203 according to the modification has the same function as that of the display control section 105 included in the information processor 10 according to the embodiment shown in FIG. 5. Since the same effect is obtained, detailed description is omitted here.

The data transmission/reception section 205 includes a CPU, a ROM, a RAM, a communicating device and the like. The data transmission/reception section 205 transmits various kinds of information outputted from the user operation information generating section 201 and the display control section 203 to the information processing server 30 via a network. The data transmission/reception section 205 also receives various kinds of information outputted from the information processing server 30 via a network, and outputs the same to the display control section 203.

The storage 207 is an example of a storage device included in the user operation device 20 according to the modification. The storage 207 may store application data corresponding to various kinds of application which the display control section 203 uses for displaying various kinds of information on the display screen. Furthermore, the storage 207 appropriately stores various parameters and processing in progress necessary to be stored for the user operation device 20 to carry out some kind of processing, or various kinds of database. The storage 207 allows the processing sections included in the user operation device 20 according to the modification to freely write thereon and read therefrom.

In the example of the modification, a case, in which the information processing server 30 stores various kinds of content data, metadata corresponding to content data and the like, is described. However, these content data and metadata may be stored in the storage 207.

An example of the function of the user operation device 20 according to the modification has been described above. The above-described component elements may include a general purpose unit or circuit, or hardware each specialized to the functions of the component elements. Or a CPU or the like may perform every function of the component elements. Therefore, the applied configuration may be appropriately changed in accordance with the technical art at the point when the embodiment is implemented.

A computer program for achieving the functions of above-described user operation device according to the modification may be created and mounted on a personal computer or the like. A computer readable record medium which stores such computer program may be provided. For example, a magnetic disk, an optical disk, a magnetic optical disk, a flash memory and the like are available for the record medium. The above-described computer program may be delivered via, for example, a network without using any record medium.

The information processing server 30 according to the modification includes mainly a display format selection control section 301, a node selecting section 303, a tree structure generating section 305, a data transmission/reception section 307, and a storage 309 as shown in FIG. 18 as an example.

The display format selection control section 301 according to the modification has the same function as that of the display format selection control section 103 included in the information processor 10 according to the embodiment shown in FIG. 5 excepting a point that various kinds of information transmitted from the user operation device 20 via a network are used. Since the same effect is obtained, detailed description is omitted here.

The node selecting section 303 and the tree structure generating section 305 also have the same configuration as that of the node selecting section 107 and the tree structure generating section 111 included in the information processor 10 according to the embodiment shown in FIG. 5. Since the same effect is obtained, detailed description is omitted here.

The data transmission/reception section 307 includes, for example, a CPU, a ROM, a RAM, a communicating device and the like. The data transmission/reception section 307 receives various kinds of information transmitted from the user operation device 20 via a network, and transmits various kinds of information outputted from the display format selection control section 301 to the user operation device 20 via a network.

The storage 309 is an example of the storage device included in the information processing server 30 according to the modification. The storage 309 stores various kinds of content data owned by a user operating the user operation device 20 and metadata or the like associated with the content data. The storage 309 may also store tree structure data corresponding to the tree structure generated by the tree structure generating section 305 or an external information processor. Furthermore, the storage 309 appropriately stores various parameters and processing in progress necessary to be stored for the information processing server 30 to carry out some kind of processing, or various kinds of database. The storage 309 allows the processing sections included in the information processing server 30 according to the modification to freely write thereon and read therefrom.

An example of the functions of the information processing server 30 according to the modification has been described above. The above-described component elements may include a general purpose unit or circuit, or hardware each specialized to the functions of the component elements. Or a CPU or the like may perform every function of the component elements. Therefore, the applied configuration may be appropriately changed in accordance with the technical art at the point when the embodiment is implemented.

A computer program for achieving the functions of the above-described information processing server according to the modification may be created and mounted on a personal computer or the like. A computer readable record medium which stores such computer program may be provided. For example, a magnetic disk, an optical disk, a magnetic optical disk, a flash memory and the like are available for the record medium. The above-described computer program may be delivered via, for example, a network without using any record medium.

FIG. 18 shows an example in which the function of the display format selection control section, the function of the node selecting section, the function of the tree structure generating section, and the storage management functions of the content data and the metadata are achieved by a single server. However, these functions may be achieved by a plurality of servers separately.

In the example shown in FIG. 18, the functions of the user operation information generating section and the display control section in the functions of the information processor 10 according to the embodiment are achieved by the user operation device 20; and the functions of the display format selection control section, the node selecting section and the tree structure generating section are achieved by the information processing server 30. However, in the plurality of processing sections included in the information processor 10 according to the embodiment shown in FIG. 5, it is changeable which of the user operation device 20 or the information processing server 30 achieves the function of which processing section accordingly.

In an example shown in FIG. 19, the user operation device 20 achieves the functions of the user operation information generating section, the display format selection control section, the display control section and the node selecting section in the functions of the information processor 10 according to the embodiment, and the information processing server 30 achieves the function of the tree structure generating section. In this example, the tree structure used for the processing of node selection may be generated or updated at arbitrary timing by the information processing server 30.

In this example, the user operation device 20 includes mainly a user operation information generating section 211, a display format selection control section 213, a display control section 215, a node selecting section 217, a data transmission/reception section 219 and a storage 221.

Here, the user operation information generating section 211, the display format selection control section 213, the display control section 215 and the storage 221 have the same configuration as those of the user operation information generating section 101, the display format selection control section 103, the display control section 105 and the storage 109 in the information processor 10 according to the embodiment respectively. Since the same effect is obtained, detailed description is omitted here.

Excepting a point that the node selecting section 217 requests the information processing server 30 to provide the tree structure generated by the information processing server 30 based on the contents managed by the user operation device 20, and performs the processing of node selection using the tree structure, the node selecting section 217 has the same configuration and obtains the like effects as the node selecting section 107 included in the information processor 10 according to the embodiment. Therefore, detailed description will be omitted here.

The data transmission/reception section 219 includes a CPU, a ROM, a RAM, a communicating device and the like. The data transmission/reception section 219 transmits the information requesting to provide the tree structure outputted from the node selecting section 217 to the information processing server 30 via a network. The data transmission/reception section 219 also receives the information on the generated tree structure, which is outputted from the information processing server 30 via network, and outputs to the node selecting section 217.

An example of the function of the user operation device 20 according to the modification has been described above. The above-described component elements may include a general purpose unit or circuit, or hardware each specialized to the functions of the component elements. Or a CPU or the like may perform every function of the component elements. Therefore, the applied configuration may be appropriately changed in accordance with the technical art at the point when the embodiment is implemented.

A computer program for achieving the functions of the above-described user operation device according to the modification may be created and mounted on a personal computer or the like. A computer readable record medium which stores such computer program may be provided. For example, a magnetic disk, an optical disk, a magnetic optical disk, a flash memory and the like are available for the record medium. The above-described computer program may be delivered via, for example, a network without using any record medium.

The information processing server 30 includes mainly a data transmission/reception section 311, a tree structure generating section 313 and a storage 315.

The data transmission/reception section 311 includes, for example, a CPU, a ROM, a RAM, a communicating device and the like. The data transmission/reception section 311 receives a request to provide the tree structure transmitted from the user operation device 20 via a network, and transmits the information on tree structure generated by the tree structure generating section 313 described below to the user operation device 20 via a network.

The tree structure generating section 313 according to the modification is a processing section that carries out the clustering processing of contents based on the contents managed by the user operation device 20 to generate a tree structure representing a clustering result. The tree structure generating section 313 has the same configuration and same effect as that of the tree structure generating section 111 included in the information processor 10 according to the embodiment. Therefore, detailed description is omitted here.

The storage 315 is an example of the storage device included in the information processing server 30 according to the modification. Furthermore, the storage 315 appropriately stores various parameters and processing in progress necessary to be stored for the information processing server 30 to carry out some kind of processing, or various kinds of database. The storage 315 allows the processing sections included in the information processing server 30 according to the modification to freely write thereon and read therefrom.

An example of the function of the information processing server 30 according to the modification has been described above. The above-described component elements may include a general purpose unit or circuit, or hardware each specialized to the functions of the component elements. Or a CPU or the like may perform every function of the component elements. Therefore, the applied configuration may be appropriately changed in accordance with the technical art at the point when the embodiment is implemented.

A computer program for achieving the functions of the above-described information processing server according to the modification may be created and mounted on a personal computer or the like. A computer readable record medium which stores such computer program may be provided. For example, a magnetic disk, an optical disk, a magnetic optical disk, a flash memory and the like are available for the record medium. The above-described computer program may be delivered via, for example, a network without using any record medium.

A first modification of the information processor 10 according to the embodiment has been described above referring to FIG. 18 and FIG. 19.

### (Hardware Configuration)

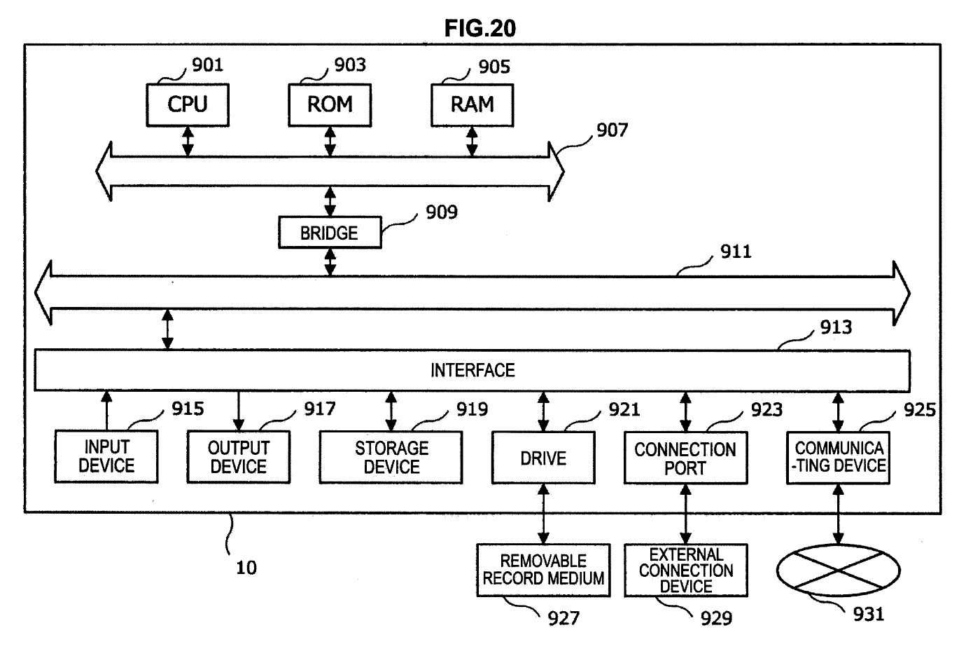

Now referring to FIG. 20, hardware configuration of the information processor 10 according to the embodiment of the present disclosure will be described in detail. FIG. 20 is a block diagram for explaining the hardware configuration of the information processor 10 according to the embodiment of the present disclosure.

The information processor 10 includes mainly a CPU 901, a ROM 903 and a RAM 905. The information processor 10 further includes a host bus 907, a bridge 909, an external bus 911, an interface 913, an input device 915, an output device 917, a storage device 919, a drive 921, a connection port 923 and a communicating device 925.

The CPU 901 functions as an arithmetic processing unit and a control device to control entire or a part of operation in the information processor 10 in accordance with various kinds of programs recorded in the ROM 903, RAM 905, storage device 919 or removable record medium 927. The ROM 903 stores programs, operation parameters and the like used by the CPU 901. The RAM 905 temporarily stores programs used by the CPU 901, and parameters which are appropriately changed during executing the programs. These are connected to each other through a host bus 907 including an internal bus such as CPU bus.

The host bus 907 is connected to an external bus 911 such as PCI (peripheral component interconnect/interface) bus via a bridge 909.

The input device 915 is an operation device for allowing a user to operate thereon including, for example, a mouse, a keyboard, a touch panel, a button, a switch, a lever and the like. The input device 915 may be, for example, a remote control device (so-called, remote) which uses infrared light or other radio wave, or an external connection device 929 such as a mobile phone, a PDA or the like corresponding to the operation of the information processor 10. The input device 915 further includes, for example, an input control circuit which generates an input signal based on information input by a user and outputs the same to the CPU 901 using the above-described operation device. By operating the input device 915, a user of the information processor 10 is able to input various kinds of data to give an instruction of a processing operation to the information processor 10.

The output device 917 includes a device which is capable of providing obtained information to a user in a visual or auditory manner. As such device, display devices including a CRT display device, a liquid crystal display device, a plasma display device, an EL display deice and a lamp and the like; audio output devices such as speaker, head phone and the like; a printer unit; a mobile phone; a facsimile and the like are available. The output device 917 outputs, for example, a result obtained by various kinds of processing made by the information processor 10. In particular, the display device displays the result of various kinds of processing made by the information processor 10 in a form of text or an image. On other hand, an audio output device converts audio signals of reproduced voice data or acoustic data into analog signals and outputs the same.

The storage device 919 is an example of a storage device configured for storing data of the information processor 10. The storage device 919 may be, for example, magnetic memory devices such as a HDD (hard disk drive), a semiconductor memory device, an optical memory device or an optical magnetic memory device. The storage device 919 stores a program executed by the CPU 901, various kinds of data, and various kinds of data obtained from the outside.

The drive 921 is a reader/writer for record medium, which is included in the information processor 10 or externally provided thereto. The drive 921 reads information recorded in a magnetic disk, an optical disk, a magnetic optical disk, or a removable record medium 927 such as semiconductor memory or the like mounted thereon, and outputs the same to the RAM 905. The drive 921 can also write a record on a magnetic disk, an optical disk, a magnetic optical disk mounted thereon, or a removable record medium 927 such as semiconductor memory or the like. The removable record medium 927 may be, for example, a DVD media, a HD-DVD media, a Blu-ray media or the like. The removable record medium 927 may be a CompactFlash (registered mark), a flash memory, or an SD memory card (secure digital memory card) or the like. The removable record medium 927 may be, for example, an IC card (integrated circuit card) mounted with non-contact IC chip or an electronic device.

The connection port 923 is a port for directly connecting a device to the information processor 10. As an example of the connection port 923, a USB (universal serial bus) port, an IEEE 1394 port, an SCSI (small computer system interface) port and the like are available. As another example of the connection port 923, an RS-232C port, an optical audio terminal, an HDMI (high-definition multimedia interface) port and the like are available. By connecting the external connection device 929 to the connection port 923, the information processor 10 obtains various kinds of data directly from the external connection device 929 and provides various kinds of data to the external connection device 929.

The communicating device 925 is a communication interface including, for example, a communication device or the like for connecting to communication network 931. The communicating device 925 may be, for example, a wired or wireless LAN (local area network), Bluetooth (registered mark) or a communication card for WUSB (Wireless USB) or the like. The communicating device 925 may be a router for optical communication, a router for ADSL (asymmetric digital subscriber line) or a modem for various kinds of communication. The communicating device 925 is capable of transmitting and receiving signals via, for example, Internet or other communication device in accordance with a predetermined protocol like, for example, TCP/IP. The communication network 931 connected to the communicating device 925 may include a network or the like connected in a wired or wireless manner such as for example, Internet, a home LAN, an infrared communication, a radiofrequency communication or a satellite communication.

A example of hardware configurations capable of achieving the functions of the information processor 10 according to the embodiment of the present disclosure has been described above. The above-described component elements may include a general purpose unit or circuit, or hardware each specialized to the functions of the component elements may be included. Therefore, the applied configuration may be appropriately changed in accordance with the technical art at the point when the embodiment is implemented.

The user operation device 20 and the information processing server 30 described in the first modification of the information processor according to the first embodiment of the present disclosure have the same configuration as the hardware configuration of the information processor 10 according to the embodiment of the present disclosure. Therefore, detailed description is omitted here.

Preferred embodiments of the present disclosure have been described in detail referring to the appended drawings. However, technical range of the present disclosure is not limited to the examples described above. It is clear that a person ordinarily skilled in the art of the present disclosure may easily conceive various changes or modifications within a range of technical spirit disclosed in the claims.

It should be understood that such changes or modifications are included in the technical range of the present disclosure.

Additionally, the present technology may also be configured as below.

(1) An information processor, comprising:

a display format selection control section that selects, in accordance with a display screen, a display format for displaying at least a part of a feature space prescribed based on a predetermined feature quantity and a set of content data associated with positional information representing a position in the feature space as metadata in combination with each other; and

a node selecting section that uses a tree structure, in which the content data are prescribed as leaf nodes and a set of nodes, in which the distance between the nodes in the feature space satisfies predetermined conditions, is prescribed as a parent node of the nodes satisfying the predetermined conditions, to select a node which satisfies the predetermined conditions from the nodes included in the tree structure in accordance with the size of a displayed feature space as the feature space displayed on the display screen,

wherein the node selecting section selects, from the nodes positioned outside of the displayed feature space, a node as an exo-display screen node positioned outside of the display screen, which has a largeness in the feature space corresponding to a separation distance from the displayed feature space of the relevant node, and

wherein the display format selection control section causes an object which indicates the existence of the exo-display screen node selected by the node selecting section to be displayed within the display screen.

(2) The information processor according to (1), wherein the node selecting section selects nodes each having a largeness similar to each other in the feature space as display nodes to be displayed on the display screen based on an index which represents a largeness in the feature space determined in accordance with the size of the displayed feature space.
(3) The information processor according to (1) or (2), wherein the display format selection control section causes a direction indicator which indicates a direction where the relevant exo-display screen node exists as an object which indicates the existence of the exo-display screen node to be displayed within the display screen.
(4) The information processor according to any one of (1) to (3), wherein the node selecting section:

determines a range of hierarchy to be searched for when searching for the nodes included in the tree structure in accordance with the index representing largeness in the displayed feature space;

determines whether the largeness in the feature space corresponding to the node included in the focused hierarchy intersects with the displayed feature space in order from the hierarchy included in a route node;

selects the nodes which do not intersect with the displayed feature space as the exo-display screen nodes and determines all child nodes of the node that intersects with the displayed feature space as nodes to be focused in a lower hierarchy of the focused hierarchy; and

determines whether the largeness in the feature space corresponding to the relevant node intersects with the displayed feature space with respect to each of the focused nodes in the lower hierarchy.

(5) The information processor according to (4), wherein, when the hierarchy including the focused node is a boundary hierarchy in a range of the hierarchies to be searched for in the lower hierarchies, the node selecting section selects all nodes to be focused in the relevant hierarchy as the nodes to be displayed or the exo-display screen nodes.
(6) The information processor according to any one of (3) to (5), wherein the display format selection control section further causes at least one of an object indicating a name of the exo-display screen node or an object indicating the separation distance to the exo-display screen node to be displayed as an object that indicates the existence of the exo-display screen node.
(7) The information processor according to (6), wherein the display format selection control section switches between display and non-display independently among the direction indicator, the object indicating the name of the exo-display screen node and the object indicating the separation distance to the exo-display screen node in accordance with a user's operation or preset conditions.
(8) The information processor according to any one of (1) to (7), wherein a reduction ratio or a magnification ratio is used as a scale that indicates the size of the displayed feature space when at least a part of the feature space is displayed on the display screen.
(9) The information processor according to any one of (1) to (8), wherein the feature space is a space that represents a position on the earth surface prescribed by degrees of latitude and longitude.
(10) The information processor according to any one of (1) to (8), wherein the feature space is a space prescribed by a feature quantity that specifies a position on a plane or on a space.
(11) An information processing method, comprising:

selecting nodes that satisfy predetermined conditions from nodes included in a tree structure in accordance with the size of a displayed feature space which is a feature space to be displayed on a display screen by using the tree structure that includes content data as a leaf node, which is associated with positional information representing a position in the feature space prescribed based on a predetermined feature quantity as metadata and a set of nodes in which the distance among the nodes in the feature space satisfies predetermined conditions is prescribed as a parent node of the nodes which satisfy the relevant predetermined conditions; and

selecting a display format for displaying at least a part of the feature space and at least a part of the selected nodes in accordance with the display screen,

wherein, when selecting the nodes, a node which has a largeness in the feature space corresponding to the separation distance from the displayed feature space of the relevant node is selected as an exo-display screen node which is positioned outside of the display screen from the nodes positioned outside of the displayed feature space, and

wherein when selecting the display format, an object indicating existence of the selected exo-display screen node is caused to be displayed within the display screen.

(12) A program causing a computer to perform:

a display format selection control function that selects, in accordance with a display screen, a display format for displaying at least a part of a feature space prescribed based on a predetermined feature quantity and a set of content data associated with positional information representing a position in the feature space as metadata in combination with each other; and

a node selecting function that uses a tree structure in which the content data are prescribed as leaf nodes and a set of nodes in which the distance between the nodes in the feature space satisfies predetermined conditions is prescribed as a parent node of the nodes satisfying the predetermined conditions to select a node which satisfies the predetermined conditions from the nodes included in the tree structure in accordance with the size of a displayed feature space as the feature space displayed on the display screen,

wherein the node selecting function selects, from the nodes positioned outside of the displayed feature space, a node as an exo-display screen node positioned outside of the display screen, which has a largeness in the feature space corresponding to a separation distance from the displayed feature space of the relevant node, and

wherein the display format selection control function causes an object which indicates the existence of the exo-display screen node selected by the node selecting section to be displayed within the display screen.

The present disclosure contains subject matter related to that disclosed in Japanese Priority Patent Application JP 2011-124759 filed in the Japan Patent Office on Jun. 3, 2011, the entire content of which is hereby incorporated by reference.

What is claimed is:

1. An information processor, comprising:
a display format selection control section that selects, in accordance with a display screen, a display format for displaying at least a part of a feature space prescribed based on a predetermined feature quantity and a set of content data associated with positional information representing a position in the feature space as metadata in combination with each other, and
a node selecting section that uses a tree structure, in which the content data are prescribed as leaf nodes and a set of nodes, in which the distance between the nodes in the feature space satisfies predetermined conditions, is prescribed as a parent node of the nodes satisfying the predetermined conditions, to select a node which satisfies the predetermined conditions from the nodes included in the tree structure in accordance with the size of a displayed feature space as the feature space displayed on the display screen,
wherein the node selecting section selects, from the nodes positioned outside of the displayed feature space, a node as an exo-display screen node positioned outside of the display screen, which has a largeness in the feature space corresponding to a separation distance from the displayed feature space of the relevant node, and
wherein the display format selection control section causes an object which indicates the existence of the exo-display screen node selected by the node selecting section to be displayed within the display screen.

2. The information processor according to claim 1, wherein the node selecting section selects nodes each having a largeness similar to each other in the feature space as display nodes to be displayed on the display screen based on an index which represents a largeness in the feature space determined in accordance with the size of the displayed feature space.

3. The information processor according to claim 2, wherein the display format selection control section causes a direction indicator which indicates a direction where the relevant exo-display screen node exists as an object which indicates the existence of the exo-display screen node to be displayed within the display screen.

4. The information processor according to claim 3, wherein the node selecting section:
determines a range of hierarchy to be searched for when searching for the nodes included in the tree structure in accordance with the index representing largeness in the displayed feature space;
determines whether the largeness in the feature space corresponding to the node included in the focused hierarchy intersects with the displayed feature space in order from the hierarchy included in a route node;
selects the nodes which do not intersect with the displayed feature space as the exo-display screen nodes and determines all child nodes of the node that intersects with the displayed feature space as nodes to be focused in a lower hierarchy of the focused hierarchy; and
determines whether the largeness in the feature space corresponding to the relevant node intersects with the displayed feature space with respect to each of the focused nodes in the lower hierarchy.

5. The information processor according to claim 4, wherein, when the hierarchy including the focused node is a boundary hierarchy in a range of the hierarchies to be searched for in the lower hierarchies, the node selecting section selects all nodes to be focused in the relevant hierarchy as the nodes to be displayed or the exo-display screen nodes.

6. The information processor according to claim 3, wherein the display format selection control section further causes at least one of an object indicating a name of the exo-display screen node or an object indicating the separation distance to the exo-display screen node to be displayed as an object that indicates the existence of the exo-display screen node.

7. The information processor according to claim 6, wherein the display format selection control section switches between display and non-display independently among the direction indicator, the object indicating the name of the exo-display screen node and the object indicating the separation distance to the exo-display screen node in accordance with a user's operation or preset conditions.

8. The information processor according to claim 1, wherein a reduction ratio or a magnification ratio is used as a scale that indicates the size of the displayed feature space when at least a part of the feature space is displayed on the display screen.

9. The information processor according to claim 1, wherein the feature space is a space that represents a position on the earth surface prescribed by degrees of latitude and longitude.

10. The information processor according to claim 1, wherein the feature space is a space prescribed by a feature quantity that specifies a position on a plane or on a space.

11. An information processing method, comprising:
selecting nodes that satisfy predetermined conditions from nodes included in a tree structure in accordance with the size of a displayed feature space which is a feature space to be displayed on a display screen by using the tree structure that includes content data as a leaf node, which is associated with positional information representing a position in the feature space prescribed based on a predetermined feature quantity as metadata and a set of nodes in which the distance among the nodes in the feature space satisfies predetermined conditions is prescribed as a parent node of the nodes which satisfy the relevant predetermined conditions; and
selecting a display format for displaying at least a part of the feature space and at least a part of the selected nodes in accordance with the display screen,
wherein, when selecting the nodes, a node which has a largeness in the feature space corresponding to the separation distance from the displayed feature space of the relevant node is selected as an exo-display screen node which is positioned outside of the display screen from the nodes positioned outside of the displayed feature space, and
wherein when selecting the display format, an object indicating existence of the selected exo-display screen node is caused to be displayed within the display screen.

12. A program causing a computer to perform:
a display format selection control function that selects, in accordance with a display screen, a display format for displaying at least a part of a feature space prescribed based on a predetermined feature quantity and a set of content data associated with positional information representing a position in the feature space as metadata in combination with each other; and
a node selecting function that uses a tree structure in which the content data are prescribed as leaf nodes and a set of nodes in which the distance between the nodes in the feature space satisfies predetermined conditions is prescribed as a parent node of the nodes satisfying the predetermined conditions to select a node which satisfies the predetermined conditions from the nodes included in the tree structure in accordance with the size of a displayed feature space as the feature space displayed on the display screen,
wherein the node selecting function selects, from the nodes positioned outside of the displayed feature space, a node as an exo-display screen node positioned outside of the display screen, which has a largeness in the feature space corresponding to a separation distance from the displayed feature space of the relevant node, and
wherein the display format selection control function causes an object which indicates the existence of the exo-display screen node selected by the node selecting section to be displayed within the display screen.
